(19) United States
(12) Patent Application Publication
(10) Pub. No.: US 2026/0030266 A1
(43) Pub. Date: Jan. 29, 2026

(54) Systems and Methods for Rendering Large-Scale Data Visualizations

(71) Applicant: Salesforce, Inc., San Francisco, CA (US)

(72) Inventor: Subrata Ashe, Walnut Creek, CA (US)

(21) Appl. No.: 19/198,994

(22) Filed: May 5, 2025

Related U.S. Application Data
(63) Continuation-in-part of application No. 19/009,856, filed on Jan. 3, 2025.
(60) Provisional application No. 63/676,240, filed on Jul. 26, 2024.
(60) Provisional application No. 63/750,183, filed on Jan. 27, 2025.

(51) Int. Cl. G06F 16/28; G06F 16/22

(52) U.S. Cl. CPC G06F 16/287; G06F 16/2246

(57) ABSTRACT

A computer system obtains an initial dataset for rendering a data visualization. The initial dataset includes a plurality of data points, and each data point has a respective spatial location in the visualization. The system dynamically generates a data structure, including (i) recursively dividing the plurality of data points into a plurality of nodes until each node satisfies a set of criteria and (ii) allocating a respective subset of data points to each node according to a spatial location of a respective data point in the data visualization. For each node, the system recursively applies a linearization algorithm to an initial subset of data points to obtain a reduced subset of data points. The system obtains a reduced dataset, generates a data visualization according to data in the reduced dataset, and causes display of the visualization on a browser application.

### RELATED APPLICATIONS

This application is a continuation-in-part of U.S. patent application Ser. No. 19/009,856, filed Jan. 3, 2025, titled “Optimizing and Simplifying Rendering of Data Points in a Visualization,” which claims priority to U.S. Provisional Patent Application No. 63/676,240, filed, Jul. 26, 2024, titled “Optimizing and Simplifying Rendering of Data Points in a Visualization,” each of which is incorporated by reference herein in its entirety.

This application also claims priority to (i) U.S. Provisional Patent Application No. 63/750,183, filed Jan. 27, 2025, titled “GPU-Accelerated and ML-Assisted Rendering of Millions of Data Points in a Visualization,” which is incorporated by reference herein in its entirety.

### TECHNICAL FIELD

The disclosed embodiments relate generally to data analysis, and more specifically to systems, methods, and user interfaces for visualization of big data in a browser-based environment.

### BACKGROUND

The exponential growth in data generation and collection has driven the demand for sophisticated visualization techniques capable of rendering complex datasets efficiently. Visualizing large datasets effectively has become a critical requirement in various fields such as data science, finance, and scientific research.

### SUMMARY

Visualizations play a crucial role in data analysis, enabling users to discern patterns, trends, and insights from large volumes of data.

Rendering large-scale datasets (e.g., with millions of data points) in a single visualization can pose significant technical challenges, especially when using browser-based tools, due to browser memory limitations and extensive processing demands. Browser engines are designed to handle an extensive range of web applications. However, they are not optimized for the heavy computational and memory demands associated with visualizing extremely large datasets. When confronted with large-scale datasets (e.g., that includes millions of data points), a browser can quickly exceed memory limits, triggering the notorious “Aww, Snap!” error in Chrome or similar crashes in other engines. The frequent garbage collection cycles, dynamic memory allocation, and scripting overhead all contribute to sluggish performance This not only frustrates users, but also prevents them from effectively analyzing the data. Similarly, visualization of large and complex datasets in browser-based analytics Software-as-a-Service (SaaS) platforms poses substantial technical challenges in terms of ensuring rendering efficiency and system stability.

In addition, JavaScript's single-threaded execution model in most browsers intensifies the problem. While WebWorkers and WebAssembly offer partial workarounds, fully exploiting hardware acceleration remains non-trivial within a traditional browser environment. These limitations underscore the need for more advanced rendering approaches that can scale effectively without sacrificing interactivity.

Accordingly, there is a need for improved methods and systems for optimizing big data visualization. Visualizations must strike a balance between preserving essential information and maintaining smooth performance. In most scenarios, users are less concerned with individual data points and more focused on higher-level trends, clusters, and overall structures. Accordingly, an effective approach should simplify the data intelligently, allowing users to derive business insights with relevant rendering while maintaining visual accuracy and clarity.

Some embodiments of the present disclosure provide a novel technical solution to the aforementioned technical problems by combining a modified Douglas-Peucker (DP) algorithm with a QuadTree data structure for hierarchical spatial indexing, to optimize and simplify the rendering of large datasets. By intelligently segmenting and refining data points based on dynamic thresholds, the disclosed approaches eliminate redundant information while preserving critical features, thereby minimizing the rendering load. The modified QuadTree partitioning with Web Workers ensures that only the most relevant subsets of data are optimally processed, leading to a scalable method capable of handling millions of marks without compromising interactivity or visual fidelity.

Some embodiments implement a smart GPU-assisted parallelization to supplement the DP algorithm and QuadTree data structure. In accordance with some embodiments, resource-intensive computations can be smartly and dynamically offloaded from one or more central processing unit (CPUs) to one or more graphics processing units (GPUs). By executing the computationally heavy steps, such as distance calculations for line simplification, on the GPU, the disclosed embodiments leverage the massively parallel architecture of the GPU to handle millions of points more efficiently while devoting CPU resources to manage tasks such as building the QuadTree index and coordinating data transfers.

Some embodiments integrate a machine learning (ML) component (e.g., on the CPU side). As disclosed, the ML component is configured to adapt simplification parameters in real time, ensuring that high-interest areas of a data visualization receive finer details while less critical regions of the data visualization undergo more aggressive simplification.

In some embodiments, the disclosed techniques improve over existing browser-based rendering approaches by:
(i) Reducing data complexity: The disclosed embodiments reduce data complexity by simplifying (e.g., filtering) a dataset to emphasize crucial shapes and patterns without overwhelming the user with redundant detail.
(ii) Faster Processing Time: The implementation of spatial subdivision and parallel computations can accelerate rendering and reduce processing time
(iii) Improved resource utilization. For example, the disclosed embodiments improve the computer system by reducing or voiding excessive Java Script memory usage and browser resource utilization. For example, as disclosed in some embodiments, the JavaScript memory usage can be reduced by about 78%; and
(iv) Enhancing user experience. The disclosed embodiments improve user experience by providing smoother and faster visual interactions at reduced rendering times. In some embodiments, the rendering time can be reduced by about 98%.

As disclosed, the DP algorithm with QuadTree data structure can be applied across various chart types, including line charts, bar charts, and scatter plots. The adaptability of the approach allows for configurable gains, ensuring that it can be tailored to specific visualization needs. The present disclosure provides a robust technical solution to the technical challenges of rendering large-scale visualizations. The disclosed embodiments provide a practical and highly efficient method for real-time data analysis and visualization in browser environments.

The systems, methods, and user interfaces of this disclosure each have several innovative aspects, no single one of which is solely responsible for the desirable attributes disclosed herein.

In accordance with some embodiments, a method for visualizing large datasets is performed by a computing device executing a browser application. The method includes obtaining a dataset for rendering a data visualization. The dataset includes a plurality of data points. The method includes selecting, from the plurality of data points, a first subset of data points according to a statistical data distribution of the dataset. The method includes recursively applying a first algorithm (e.g., a linearization algorithm or a line simplification algorithm such as Douglas-Peucker algorithm or Visvalingam-Whyatt algorithm) to the first subset of data points to obtain a final subset of data points, where each of first subset of data points and the final subset of data points has a fewer number of data points than the plurality of data points. The method includes rendering a data visualization using the browser application. The data visualization includes a plurality of data marks corresponding to the final subset of data points. The method includes displaying, on the browser application, the data visualization including the plurality of data marks.

In accordance with some embodiments, a method for visualizing large-scale datasets is performed at a computer system that includes one or more processors and memory. The method includes obtaining an initial dataset for rendering a data visualization, the initial dataset including a plurality of data points that is spatially distributed in the data visualization and each data point has a respective spatial location in the data visualization. The method includes dynamically generating a data structure, including (i) recursively subdividing a bounding region of the data visualization into a plurality of nodes until each node satisfies a set of one or more criteria and allocating a respective initial subset of data points, of the plurality of data points, to each node of the plurality of nodes according to a spatial location of a respective data point in the data visualization. The method includes, for each node of the plurality of nodes, recursively applying a linearization algorithm to the respective initial subset of data points corresponding to the respective node to obtain a respective reduced subset of data points. The respective reduced subset of data points has a fewer number of data points than the respective initial subset of data points. The method includes obtaining a reduced dataset comprising a plurality of reduced subsets of data points from the plurality of nodes. The method includes generating the data visualization according to data in the reduced dataset. The method includes causing display of the data visualization on a browser application.

In some embodiments, dynamically generating the data structure includes determining a plurality of data segments for the initial dataset according to a plurality of spatial regions of the data visualization such that each data segment corresponds to a respective spatial region. The method includes, for each data segment, applying a machine learning model to determine an optimum number of nodes for the respective data segment so as to balance geometric fidelity of the respective spatial region of the data visualization with real-time performance.

In accordance with some embodiments, a computing device includes a display, one or more processors, and memory coupled to the one or more processors. The memory stores one or more programs configured for execution by the one or more processors. The one or more programs include instructions for performing any of the methods disclosed herein.

In accordance with some embodiments, a computer system includes one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing device having a display, one or more processors, and memory. The one or more programs include instructions for performing any of the methods disclosed herein.

In accordance with some embodiments, a non-transitory computer readable storage medium stores one or more programs configured for execution by a computer system having one or more processors, and memory. The one or more programs include instructions for performing any of the methods disclosed herein.

Thus methods, systems, and graphical user interfaces are disclosed that optimizes the rendering of data points in data visualizations.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIG. 1 illustrates a pipeline for rendering large-scale data visualizations, in accordance with some embodiments.

FIG. 2 illustrates a hybrid pipeline for rendering large-scale data visualizations using a combination of CPU(s) and GPU(s), in accordance with some embodiments.

FIGS. 3A and 3B illustrate example views of a QuadTree data structure, in accordance with some embodiments.

FIG. 4 is an example algorithm for CPU-driven QuadTree construction, in accordance with some embodiments.

FIG. 5 is an example algorithm for GPU-driven QuadTree construction, in accordance with some embodiments.

FIG. 6 is an example algorithm for GPU-accelerated point simplification process using the Douglas-Peucker algorithm, in accordance with some embodiments.

FIG. 7 is an example algorithm showing ML-assisted stopping criteria for adaptive simplification, in accordance with some embodiments.

FIG. 8 is an example algorithm of the training process, in accordance with some embodiments.

FIG. 9 illustrates a training pipeline for training the ML model, in accordance with some embodiments.

FIG. 10A illustrates a data visualization that is rendered using all data points of a dataset, in accordance with some embodiments.

FIG. 10B illustrates a data visualization that is rendered using a subset of data points of the same dataset that is used to render the visualization in FIG. 10A, in accordance with some embodiments.

FIGS. 10C-1 and 10C-2 illustrate zoomed-in regions of the data visualizations of FIG. 10A and FIG. 10B, respectively, in accordance with some embodiments.

FIG. 11 provides a block diagram of a computing device, in accordance with some embodiments.

FIG. 12 provides a block diagram of a server system, in accordance with some embodiments.

FIGS. 13A to 13F provide a flowchart of a method for visualizing large datasets, in accordance with some embodiments.

FIGS. 14A to 14G provide a flowchart of an example process for visualizing large datasets, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

Visualizing large datasets effectively is a growing concern in fields as diverse as data science, finance, and scientific research. While web technologies have advanced significantly in recent years, they still encounter considerable challenges when rendering millions of data points in real-time.

According to some embodiments off the present disclosure, techniques such as the Douglas-Peucker (DP) algorithm, the Visvalingam-Whyatt (VW) algorithm, and/or a QuadTree data structure can be employed to optimize the rendering of large datasets in a visualization.

Some embodiments implement the DP algorithm for geometric simplification. Some embodiments implement the QuadTree data structure for spatial partitioning. Together, they lay the groundwork for more advanced optimizations disclosed herein, including GPU offloading and machine learning-based enhancements. An optimized approach must find a balance between conveying high-level trends and avoiding information overload. Intelligent simplification and adaptive level-of-detail techniques [can maintain visual fidelity while reducing the number of elements that must be drawn. This results in faster load times, smoother panning and zooming, and fewer memory bottlenecks. Ultimately, a responsive and clear visualization fosters deeper engagement and more confident decision-making.

DP algorithm. The DP algorithm simplifies polylines by reducing the number of points while preserving the overall shape of the data. The DP algorithm was originally developed for cartographic applications. The essence of DP lies in reducing the total number of points in a polyline, while still preserving its overall shape within a user-defined tolerance. By discarding points that contribute minimally to the line's curvature, the DP algorithm significantly reduces the computational burden for subsequent rendering steps. The DP algorithm is adept at handling large volumes of data points by recursively removing points that do not significantly alter the visual representation of the line. This process significantly reduces the computational load, making it feasible to render large datasets more efficiently. In some embodiments, the DP algorithm works by recursively selecting the most significant points and discarding the less significant ones based on a specified tolerance level. This tolerance determines the degree of simplification, balancing between detail and performance. In some embodiments, enhancements to the DP algorithm, such as incremental sampling, parallel processing, and dynamic tolerance adjustment, further improve its efficiency and adaptability to various types of visualizations.

VW algorithm. The Visvalingam-Whyatt (VW) algorithm, or simply the Visvalingam algorithm, is an algorithm that is primarily used in cartographic generalization. The VW algorithm assigns points in a curve an importance value based on local conditions and removes points from the least important to most important. The algorithm decimates a curve composed of line segments to a similar curve with fewer points.

QuadTree Data Structure. The QuadTree data structure is another technique used to optimize data rendering. While the DP algorithm addresses the problem of excessive data points, the QuadTree data structure tackles spatial complexity. A QuadTree is a hierarchical data structure that recursively subdivides a two-dimensional space into smaller regions, or quadrants, based on the distribution of the data points. At each level of the hierarchy, points are grouped into manageable clusters. This spatial subdivision allows for efficient organization and retrieval of data as it not only accelerates queries, such as identifying points within a certain viewport but also allows targeted processing on relevant data subsets, avoiding the overhead of handling the entire dataset at once. Accordingly, the computational overhead during the rendering process is significantly reduced. QuadTrees are particularly effective in handling large, sparse datasets where data points are unevenly distributed. By dynamically adjusting the level of subdivision based on data density, QuadTrees ensure that each region contains a manageable number of data points, facilitating faster queries and rendering.

In accordance with some embodiments of the present disclosure, by leveraging hierarchical spatial partitioning via the QuadTree data structure and intelligent geometric simplification via the DP algorithm, a foundation upon which GPU offloading and adaptive machine learning can be layered is established. The following sections outline how we integrate and enhance these concepts to deliver real-time, large-scale visualizations in modern web environments.

### Optimization

As disclosed, a series of innovations underpin the approach to processing and visualizing large datasets before rendering. This section details how incremental sampling, parallelization, dynamic runtime tolerance, and careful data structuring come together to deliver more responsive and scalable visualizations.

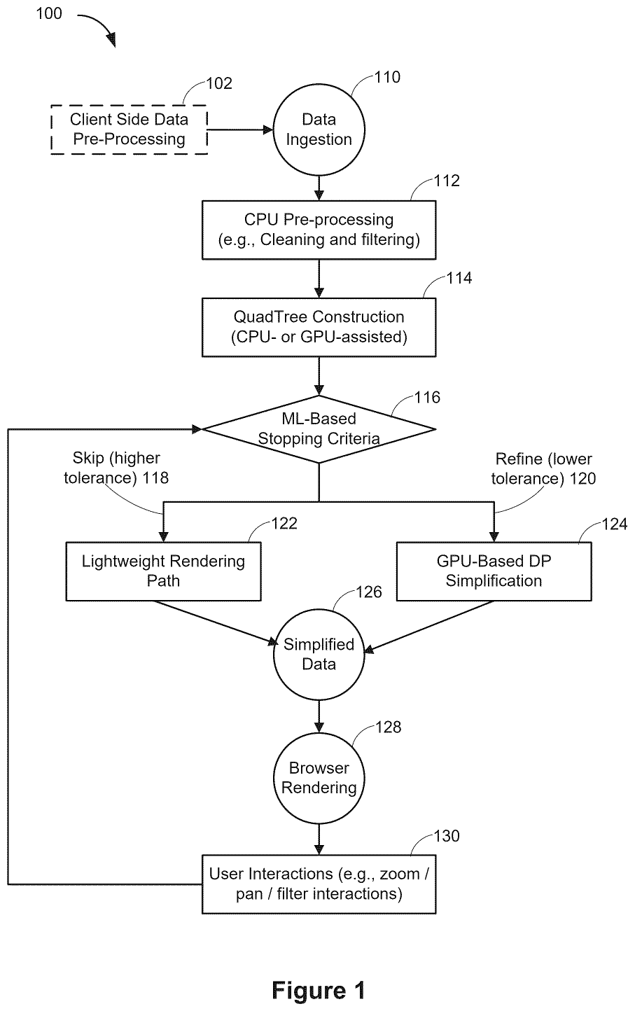

FIG. 1 illustrates an example pipeline 100 for rendering large-scale data visualizations, in accordance with some embodiments.

In accordance with some embodiments, the pipeline 100 is executed at a client device (e.g., computing device 1100). In some embodiments, the pipeline 100 is executed at a server system (e.g., server system 1200). In some embodiments, some processes of the pipeline 100 are executed at a client device whereas other processes of the pipeline 100 are executed at a server system.

In some embodiments, the pipeline 100 includes client-side data pre-processing at step 102, which is performed at the client device (e.g., computing device 1100). In some embodiments, before data (e.g., raw data, data of an initial dataset) is ingested by the server system, a client-side preprocessor execute instructions to streamline and refine the initial dataset. This provides several advantages, particularly in enhancing performance and optimizing the data for visualization.

In some embodiments, the client-side data pre-processing includes data cleaning and transformation. For example, in some embodiments, the client-side data pre-processor can perform initial data cleaning and transformation tasks. This includes handling missing values, filtering outliers, normalizing values, and converting data types. In some embodiments, data cleaning and transformation can be performed immediately after fetching the dataset, thus ensuring that only valid, consistent data is ingested. Pre-processing ensures that the data is in the best possible shape for rendering, reducing the likelihood of errors and inconsistencies.

In some embodiments, the client-side data pre-processing includes simplification and reduction. For example, in some embodiments, before passing the data to the rendering engine, the pre-processor can execute simplification algorithms. For example, the client-side data pre-processors can run a preliminary round of a linearization algorithm or data point simplification algorithm (e.g., Douglas-Peucker algorithm) to simplify the dataset before the main rendering logic. This step can the number of data points by eliminating redundant or insignificant points, thereby decreasing the computational load and memory consumption in the browser.

In some embodiments, the client-side data pre-processing includes feature extraction. For datasets with many attributes, extracting key features up front lets the visualization focus on only the dimensions most relevant to the user's goals. In some embodiments, the pre-processor can perform feature extraction to identify and retain only the most relevant features of the data. Feature extraction can be particularly useful for complex datasets with numerous attributes, enabling more focused and efficient visualizations.

In some embodiments, the client-side data pre-processing includes segmentation and batching. For example, in some embodiments, data can be segmented into smaller, more manageable batches. Breaking data into logical segments or time-based batches makes incremental updates more efficient. This segmentation allows for incremental processing and rendering, which is especially beneficial for large datasets. By processing and rendering data in smaller chunks, and not sending all data at once, the application can maintain responsiveness and avoid overwhelming the browser.

In some embodiments, the client-side data pre-processing includes client-side computation. for example, offloading some computation to the client-side reduces server demands and scale more gracefully by distributing the processing load. Browsers are increasingly capable of handling these tasks without significant performance drawbacks, especially for modest-sized datasets or partial loads. This can lead to faster data retrieval and rendering times, enhancing the overall user experience.

In some embodiments, the benefits of client-side data pre-processing include:
Improved Performance: By pre-processing data on the client side, the amount of data passed to the rendering engine is reduced, leading to faster rendering times and more efficient memory usage.
Enhanced User Experience: By pre-processing data on the client side users experience smoother interactions and quicker load times, as the pre-processing step ensures that only the most relevant and optimized data is rendered.
Scalability: In some embodiments, client-side preprocessing allows the system to handle larger datasets more effectively, distributing the processing load and preventing server bottlenecks.
Customization: Pre-processing enables more customized visualizations, as data can be tailored to specific visualization needs before rendering.

With continued reference to FIG. 1, in some embodiments, the pipeline 100 includes a data ingestion step (step 110). In the data ingestion step, raw data enters the pipeline, often in a browser environment or via a local server. In some embodiments, the raw data enters the pipeline as a data stream. In some embodiment, the raw data enters the pipeline in batches.

In some embodiments, the pipeline 100 includes CPU pre-processing (e.g., cleaning and filtering) at step 112. In accordance with some embodiments, step 112 is performed at a server system. In the CPU pre-processing step, the data is cleaned or filtered on the CPU. In some embodiments, Web Workers are used to perform the cleaning and filtering to avoid blocking the main thread.

In some embodiments, the pipeline 100 includes constructing a QuadTree data structure at step 114.

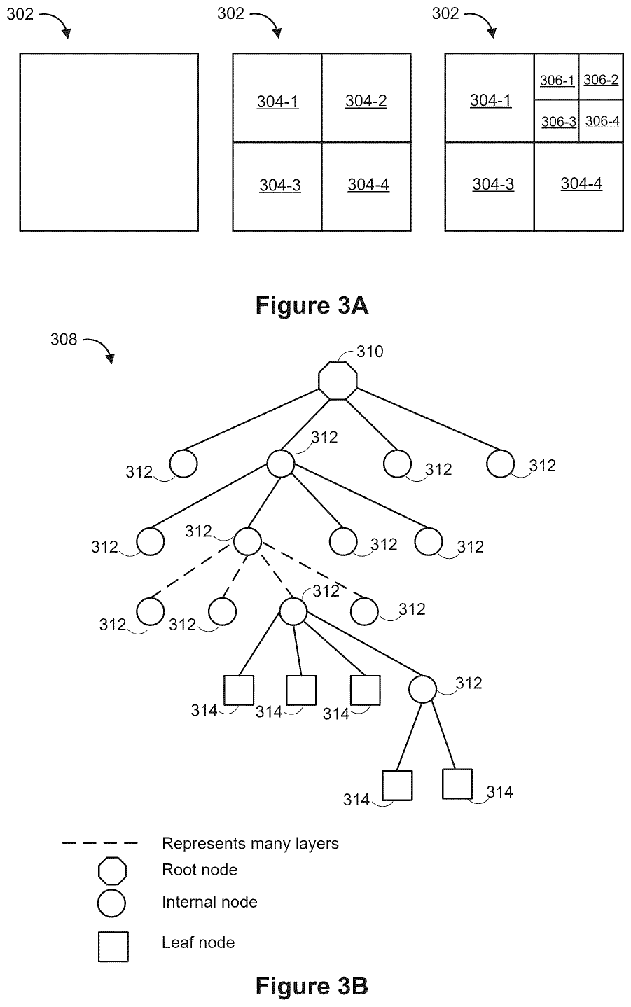

FIGS. 3A and 3B illustrate example views of a QuadTree data structure, in accordance with some embodiments.

FIG. 3A shows a two-dimensional space 302 (e.g., a bounding box). The two-dimensional space 302 is divided into four quadrants 304-1, 304-2, 304-3, and 304-4. In some embodiments, each quadrant is also known as a node. A respective quadrant 304 can continue to subdivide (e.g., with a quadrant subdividing into four more quadrants), until all the subdivisions meet certain criteria. For example, FIG. 3A shows quadrant 304-2 subdividing into four quadrants 306-1, 306-2, 306-3, and 306-4.

FIG. 3B illustrates a QuadTree data structure 308. Root node 310 represents the entire area occupied by a data visualization. The leaf nodes 314 represent the smallest subdivisions and contain the actual data points. The internal nodes are nodes between the root and leaves. The internal nodes represent larger areas and may be further subdivided.

In accordance with some embodiments of the present disclosure, the QuadTree data structure plays a vital role in organizing large datasets spatially so that only the most relevant points are processed for any given view or query. Proper construction and tuning of the QuadTree can dramatically influence both memory usage and rendering performance.

The QuadTree data structure is applied for organizing and optimizing spatial data for efficient querying and rendering. QuadTree is a hierarchical data structure which partitions a two-dimensional space into smaller regions. It works by recursively subdividing the space into quadrants, each containing a subset of data points. It also dynamically adjusts its structure based on the distribution of data points. In some embodiments, as data points and inserted or removed, the enhanced algorithm rebalances the tree to maintain optimal performance.

In accordance with some embodiments of the present disclosure, the QuadTree data structure can be constructed using CPU or GPU.

CPU Construction: In many cases, building the QuadTree on the CPU is sufficient. The CPU efficiently handles the branching logic needed to partition space, especially if the dataset is incrementally loaded or if updates are relatively infrequent. Once the QuadTree is built, subsequent queries and updates can proceed quickly.

GPU-Assisted Construction: In some embodiments, for extremely large datasets (e.g., a dataset that has at least 1 million data points, at least 2 million data points, at least 3 million data points, at least 4 million data points. at least 5 million data points, at least 6 million data points, or over 6 million data points), constructing the QuadTree (or portions of it) on the GPU may yield additional speedups. The GPU can process point sorting and bounding box calculations in parallel, reducing the time needed to subdivide the dataset. However, the complexity of synchronizing tree-building steps and transferring partial results back to the CPU can offset some of these gains. Thus, GPU-assisted construction is most beneficial when initial data ingestion is massive or when the dataset is updated frequently in large batches.

### Tuning the Minimum and Maximum Nodes

Once the structure is built, the efficiency of the QuadTree depends largely on choosing appropriate thresholds for when to subdivide. In this regard, a key aspect of the implementation of the QuadTree data structure involves tuning the minimum and maximum number data points within each node. This tuning process significantly impacts the performance and efficiency of data retrieval and rendering.

Minimum nodes (Min Nodes). The Min Nodes parameter defines how many data points (e.g., data entries) must remain in a node before the subdivision process halts. Min Nodes sets the threshold for early termination of subdivision to avoid excessive fragmentation (e.g., important for datasets with dense clusters). If a node has fewer than the specified minimum number of data points, the node will not be further subdivided. If the value of this parameter is set at too low a value, there will be numerous subdivision processes, which leads to an overly deep tree and extra traversal time will be incurred. If the value of this parameter is set too high, data may not be subdivided enough to be truly efficient. Striking the right balance ensures fast lookups without creating unnecessary overhead.

Maximum nodes (Max Nodes). The Max Nodes parameters dictates when a quadrant should be further subdivided (e.g., into smaller sub-quadrants). Max Nodes caps subdivision when regions are too sparse, preventing wasteful splitting When a quadrant's data points exceed this limit, the region subdivides into four smaller nodes. A lower maximum promotes finer partitioning, potentially speeding up queries in highly dense areas but increasing overall tree depth. A higher maximum can accelerate construction and reduce memory consumption but risks slower look-ups later on. Setting an appropriate maximum value is crucial for balancing between tree depth and spatial precision. A lower Max Nodes value ensures finer partitioning, which can improve the accuracy of data queries but may increase the tree's depth, potentially leading to higher memory usage and slower traversal times.

In some embodiments, the values for Min Nodes and Max Nodes are chosen based on factors such as GPU throughput limits or empirical testing results. The GPU throughput limits specify how many points or primitives the browser's WebGL pipeline can render at 60 frames per second (fps). For empirical testing, benchmarks are run across typical dataset sizes (10,000 to 10 million data points) and the “sweet spot” where rendering time plateaued but visual fidelity was still acceptable was determined. Example values of Min Nodes are in the range of about 55-65. Example values of Max Nodes are in the range of about 1500-1600. The numbers can be tuned slightly based on dataset density.

In some embodiments, by carefully tuning the above two parameters, the QuadTree can be optimized for specific datasets and visualization requirements. For example, sparse datasets may benefit from higher minimum and maximum values to avoid deep trees, while dense datasets might require lower values to ensure finer partitioning and accurate data retrieval.

With continued reference to FIG. 1, the pipeline includes applying a set of one or more machine-learning (ML) based stopping criteria in step 116. In some embodiments, step 116 is executed at the client device. In some embodiments, step 116 is executed at the server system.

Some embodiments introduce an additional layer of optimization by integrating a machine learning (ML) model (e.g., ML model(s) 1160) to guide the stopping criteria in both QuadTree construction and DP simplification. In some embodiments, rather than relying solely on static thresholds or heuristic rules, a trained model is configured to dynamically predict how much detail is necessary in specific regions. For instance, areas of high user interest or significant local variance might receive extra subdivision or lower tolerances, whereas less critical regions could be simplified more aggressively. See the sections on “Dynamic Runtime Tolerance,” “ML-Assisted Stopping Criteria,” and “ML-Assisted Stopping Criteria With a Lightweight Gradient-Boosting Model” described below.

In some embodiments, the ML model comprises a lightweight ML model that runs locally on the client device. In some embodiments, the ML model is configured to inspect local density, curvature, or error metrics to decide whether to refine in step 120 (e.g., decrease a tolerance value and proceed with more detailed linearization algorithm) or skip further subdivisions (e.g., increase a tolerance value) in step 118.

The ML model guides the DP simplification by determining whether to use a lightweight rendering path in step 122 or a GPU-based DP simplification in step 124.

In some embodiments, the lightweight rendering path in step 122 is performed at the client device. In the lightweight rendering path, regions deemed less critical receive less detailed processing to maintain efficiency.

In some embodiments, the GPU-based DP simplification in step 124 is performed at the client device and/or the server system. For subsets that demand higher detail, the GPU accelerates the distance calculations for the Douglas-Peucker algorithm.

In accordance with some embodiments, rather than simplifying the entire dataset in one pass, the process begins by sampling a subset of points and applying the DP algorithm (or the VW algorithm) to this reduced set. Once those segments are simplified, additional points are progressively added, and the algorithm is re-applied. This staged approach helps distribute the computational workload over multiple iterations, preventing any single step from overwhelming the system. By processing data in manageable chunks, visual feedback remains fast and fluid, allowing for the efficient handling of extensive datasets without compromising performance.

### Parallelization

Modern web environments offer multiple paths to parallelism, from Web Workers to GPU acceleration. Employing these resources can significantly improve rendering speeds for large-scale data.

CPU Parallelization with Web Workers. To further enhance performance, some embodiments of the present disclosure adapt the DP algorithm or the VW algorithm to leverage parallel processing through web workers. An example method of parallelization involves offloading certain computations such as line distance checks or data partitioning into Web Workers. Web workers allow multiple threads to execute independently, with each worker operating on a separate thread. Segments of data are processed simultaneously, in parallel, thus offloading the main thread's utilization. While this approach can yield faster results (e.g., by reducing overall latency), it also requires carefully managing inter-thread communication and ensuring synchronized data updates. Processing data in coordinated batches helps maintain a manageable granularity of work and prevents race conditions or synchronization delays. In some embodiments, the parallel processing includes partial parallel processing, with ongoing investigations to optimize this approach. In some embodiments, data is processed in batches, which help control the granularity of computation and ensure that each batch is processed efficiently without overwhelming the system.

GPU-Based Parallel Simplification. In some embodiments, for even greater speedups, the most computationally intensive tasks such as distance calculations in the DP algorithm or merging neighboring QuadTree nodes can be performed on the GPU. Data (e.g., polyline coordinates) is transferred to the GPU in buffer form, where dedicated kernels process each subset of points in parallel. The results are then streamed back to the CPU, which handles final merging and any higher-level logic.

With continued reference to FIG. 1, in some embodiments, the pipeline 100 includes step 126 where simplified data is generated at the client device.

In some embodiments, the pipeline 100 includes a browser rendering step (step 128), where final or partially simplified geometry is rendered via a web browser, using WebGL or WebGPU. In some embodiments, step 128 is performed at the client device.

In some embodiments, the pipeline 100 includes receiving one or more user interactions via the client device in step 130. The user interactions can include a zoom, pan, and/or filter interaction with the rendered visualization. As the user pans, zooms, or filters, the pipeline 100 loops back to the ML-based stopping criteria in step 116 to dynamically adapt thresholds and refine or skip details as needed.

In some embodiments, when a user interacts with the initial rendering via zooming, panning, or filtering, the ML model plays an active, dynamic role in guiding the level of geometric simplification applied to the newly relevant dataset subset. In some embodiments, the ML model is embedded in the browser and executes locally on the client device (e.g., computing device 1100). In some embodiments, the ML model executes on the server system (e.g., server 1200).

In some embodiments, responsive to user interaction, the ML model guides the level of geometric simplification applied to the newly relevant dataset subset by performing the following steps
(1) Segment Collection: After the user interaction, the system fetches or identifies the new data points falling within the updated viewport. These points are spatially organized, and grouped into logical segments based on proximity or known ordering (e.g., polylines for time series or trajectories).
(2) Feature Extraction for Each Segment. In some embodiments, for each candidate segment, the following lightweight features are computed on the client. Note that these features are compact and are generated very quickly (sub-millisecond for hundreds of segments).:
   Local point density
   Spatial spread (bounding box area)
   Curvature estimates
   Directional changes
   Existing zoom level and viewport resolution
(3) ML Model Prediction. In some embodiments, these extracted features are fed into the lightweight gradient-boosted ensemble model. The model was pretrained offline on labeled synthetic and real datasets. Its task is to predict a local error tolerance (e.g., epsilon) for Douglas-Peucker simplification. In some embodiments, the model is fully loaded into the browser memory at page load and runs entirely client-side.
(4) Tolerance Assignment. In some embodiments, the ML model outputs a per-segment tolerance value. High-density, high-curvature regions (important details) are assigned lower tolerance (preserving more points), whereas low-density, flat regions are assigned higher tolerance (more aggressive simplification).
(5) Simplification Application. The GPU-accelerated pipeline then applies Douglas-Peucker per segment, using the predicted tolerance, such that critical regions stay visually sharp whereas less critical areas are aggressively compressed to reduce the rendering load.
(6) Rendering. The simplified geometry is sent to the WebGL (or Canvas2D) renderer, which draws the final output that the user sees after interaction, optimized for perceptual quality and performance.

In Summary: For every new viewport change:
Input: Local features per data segment.
Output: A predicted simplification tolerance value per segment.
Effect: Drives how much the data is reduced before rendering, balancing speed and fidelity dynamically

### Tuning the Tolerance Fraction

The “tolerance fraction” parameter in the linearization algorithm (e.g., also known as the epsilon parameter in FP algorithm) determines how aggressively the system merges points. This parameter defines the maximum distance between the original points and the simplified curve, and balances between data reduction and visual accuracy. Setting this value too high may compromise visual detail, while setting it too low can negate many of the performance benefits gained from simplification.

Dynamic Adjustment. In some embodiments, the tolerance fraction dynamically changes at runtime, and enables the algorithm to adapt on-the-fly to local data density or user demands for level of detail. In some embodiments, the tolerance fraction is a predetermined value. For example, the predetermined value can be determined according to heuristic rules. By setting an appropriate fraction, the algorithm can fine-tune the simplification process, ensuring that significant points are retained while less critical points are removed.

Data-Driven Optimization. Different datasets have varying levels of detail and noise patterns. In some embodiments, the value of the tolerance fraction parameter is tuned based on empirical observations or predefined rules, which helps ensure that crucial features are retained while superfluous points are trimmed. Tailoring the value of the tolerance parameter based on dataset provides a mechanism to tailor the simplification process to the specific needs of the dataset. For example, high-frequency data with many fluctuations might require a lower tolerance fraction to preserve critical details, while smoother data can tolerate a higher fraction, resulting in more significant simplification.

In some embodiments, the predefined rules fall into one of four categories.

The first category has to do with density-based initialization. For example, if the number of points per viewport pixel exceeds a threshold (e.g., two points per pixel), the system would automatically raise the tolerance to aggressively simplify overlapping points. This is to ensure that there are no overlapping data points (e.g., data marks) because a user is not able to distinguish whether there is one data mark or multiple identical data marks, so the system does not to render both duplicate data marks (e.g., with the same coordinates)

The second category has to do with feature preservation priority. Here, the system looks for regions where the data forms recognizable structures. such as visible lines, curves, gradients or clusters, and the initial tolerance is capped at a maximum limit. Here, the limit is no more than 5% deviation from the original data path and this would ensure that important structures are preserved even before the model does any kind of adjustments. The third category has to do with screen resolution scanning. The starting tolerance is proportional to the inverse of the zoom level, and directly proportional to the visible area size. A visualization that is zoomed out (e.g., showing a larger area) corresponds to a higher tolerance, whereas a visualization that is zoomed in (e.g., showing a smaller area) corresponds to a smaller tolerance.

The fourth category has to do with noise band detection. For example, if local point-to-point distances are below a defined minimum threshold, points are closer than a few screen pixels apart, then there are candidates for simplification.

Balancing Performance and Accuracy. The tolerance fraction offers a direct lever for navigating the trade-off between visual fidelity (e.g., visual accuracy) and speed (e.g., performance). Lower values yield more detail but higher computational overhead; higher values simplify aggressively at the risk of losing meaningful information. By dynamically adjusting the value of this parameter, the algorithm ensures efficient rendering without compromising on the essential visual characteristics of the data.

### Dynamic Runtime Tolerance

Traditional implementations of the DP algorithm rely on a fixed tolerance level to determine the degree of simplification. Some implementations of the present disclosure incorporate a dynamic runtime tolerance, which allows the algorithm to adaptively determine the best tolerance level based on the characteristics of the data. In some embodiments, the dynamic runtime tolerance is controlled by a parameter called “tolerance fraction,” which enables the algorithm to adapt its threshold based on real time data characteristics.

The tolerance fraction governs how much geometric simplification is allowed per data segment after subdivision. In particular, it would assign an allowable error when simplifying points using the DP or equivalent methods. As disclosed, the tolerance fraction is not hand-coded or manually set. It is automatically predicted by a machine learning model (e.g., ML model(s) 1160) based on a set of criteria, including local density of the data points, zoom level of the data visualization (e.g., zoom in and zoom out), and/or local feature complexity. For example, the spread of the data or the curvature of the data, or the density of the data.

The ML model 1160 is a trained model that is trained on a set of labeled training data. For example, labeled training data can be generated by manually sampling various zoom levels, viewport sizes and data distribution, and then recording human preferred tolerance values, balancing speed versus perceived quality. The ML model is trained to predict optimal tolerance values across unseen scenarios, and is configured to produce the tolerance fraction (e.g., tolerance value) dynamically during user interaction to optimize visual clarity when needed and maximize performance.

This adaptive approach helps maintain a high degree of visual accuracy while reducing computational overhead for less critical regions of the dataset. By fine-tuning the simplification in real time, the system better accommodates varying data densities and data complexities, automatically trading off between speed and detail as needed.

### GPU/CPU Assisted Construction and Parallel Simplification

Modern GPU architectures provide massive parallelism, making them ideal for accelerating tasks that involve repetitive operations on large data arrays such as line distance checks, geometric queries, and merging operations. When combined with a CPU-based orchestration layer, the result is a hybrid pipeline that capitalizes on each processor's strengths. This section details how QuadTree construction and DP simplification can be split between CPU and GPU, along with the methodologies to measure performance and ensure a robust, scalable system.

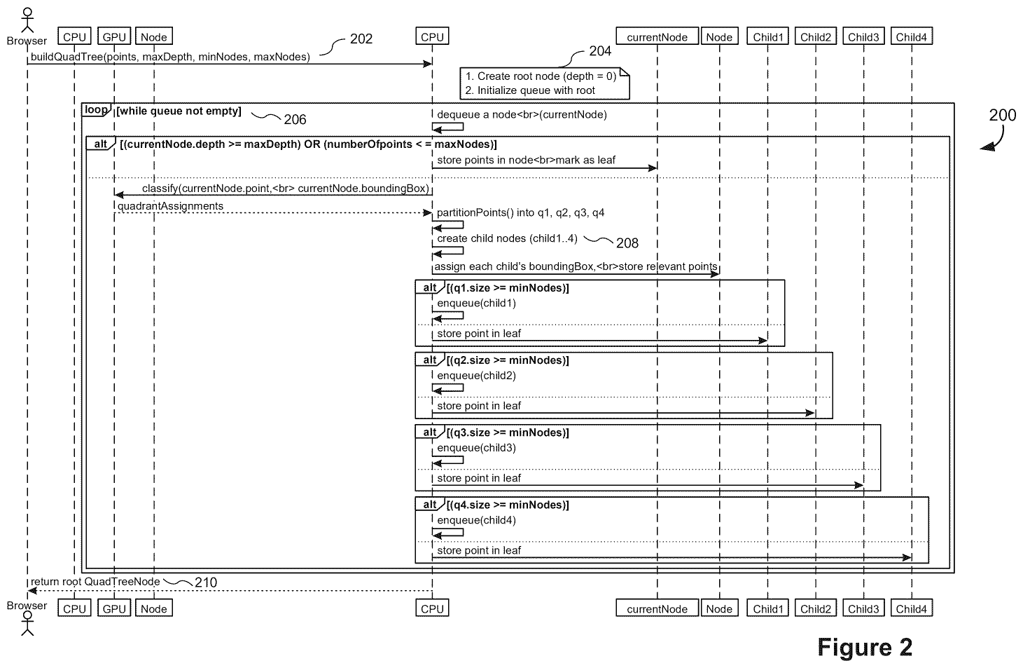

FIG. 2 illustrates a hybrid pipeline 200 for rendering large-scale data visualizations using a combination of CPU(s) and GPU(s), in accordance with some embodiments. In some embodiments, the pipeline 200 is executed at the client side. In some embodiments, the pipeline 200 is executed at the server side. In some embodiments, the pipeline 200 is executed at a combination of both client and server sides.

In some embodiments, the pipeline 200 includes an initialization step 202. In this step, the browser invokes buildQuadTree (points, maxDepth, minNodes, maxNodes) on the QuadTreeBuilder (CPU). A root node is created, and the CPU places it into a queue in step 204.

The pipeline includes a loop over queue (step 206). While there are nodes in the queue, each node is de-queued and examined. If either the maxDepth is reached or the node's point count is below maxNodes, the node becomes a leaf with no further subdivision. Otherwise, the CPU sends the node's points to the GPU for classification into quadrants, then partitions them on the CPU side.

In some embodiments, the CPU creates up to four child nodes (child1, child2, child3, child4) (step 208), and assigns them their respective bounding boxes and points. If a child has at least minNodes points, it is enqueued for further subdivision in the loop. If not, it becomes a leaf immediately.

Once all nodes have been processed, the CPU returns the root node to the browser in step 210, concluding QuadTree construction.

This sequence diagram highlights how classification tasks can be offloaded to the GPU, while the CPU manages the higher-level logic, queue operations, and node creation. This can be adapted for partial concurrency with Web Workers or custom memory management steps.

The following is an example of how the pipeline 100 in FIG. 1 can be using a combination of CPU(s) and GPU(s):
(1) Data Ingestion (CPU): The CPU receives raw data (e.g., polylines, point sets, or map features) and pre-processes them (basic cleaning, filtering).
(2) Spatial Partitioning (CPU or GPU): A QuadTree is partially or fully constructed based on initial bounding boxes. The CPU coordinates the top-level subdivision logic, whereas the GPU may handle batch computations (e.g., point-in-region checks) if the data size is particularly large.
(3) Parallel Simplification (GPU): The GPU executes distance calculations for DP or merges data from adjacent QuadTree leaves in parallel kernels. Results are fed back to the CPU in aggregated form.
(4) Final Assembly (CPU): The CPU merges partial simplifications from GPU output, fixes boundary issues, and finalizes the data structure. The CPU or GPU (depending on the chosen framework) can then render or hand off data for rendering.

As disclosed, this multi-stage design balances the CPU's flexibility (handling complex branching logic, data streaming) with the GPU's raw computational throughput for large-scale numeric tasks.

QuadTree Construction: CPU vs. GPU

While a traditional QuadTree is typically built on the CPU in a recursive manner, the sheer number of data points (potentially in the millions) can make the process a bottleneck. Offloading certain steps to the GPU can accelerate this stage.

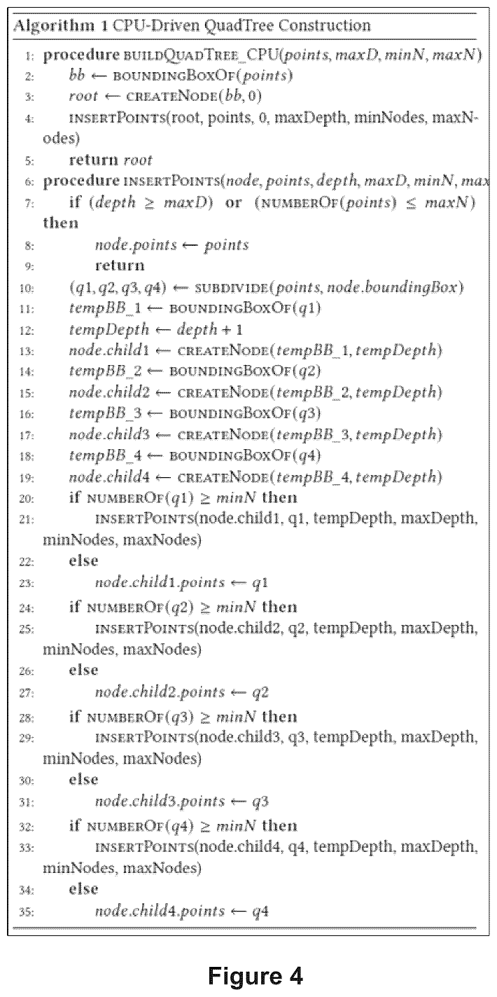

CPU-Driven Construction. The CPU-driven approach suits scenarios where data arrives in streams or partial batches. FIG. 4 is an example algorithm for CPU-driven QuadTree construction, in accordance with some embodiments.
Bounding Box: The bounding region for the entire dataset is computed once and assigned to the root node.
Subdivide: Each level splits data into four subsets according to quadrant boundaries.
Recursive Insertion: Once a node has fewer than Max Nodes points, or the maximum depth is reached, the node stops subdividing and stores its data.

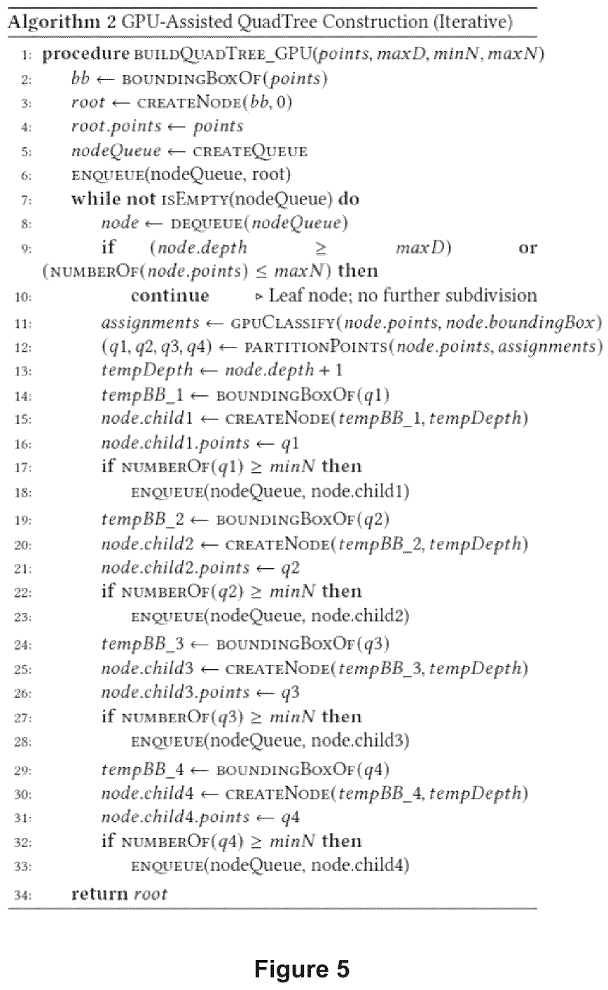

GPU-Assisted Construction. When dealing with millions of points, GPU-based classification will significantly accelerate subdivision. Instead of a purely recursive approach, a queue-based or iterative pattern is used. FIG. 5 is an example algorithm for GPU-driven QuadTree construction, in accordance with some embodiments.
Iterative Subdivision: A queue processes nodes in sequence rather than relying on deep recursion, which can be beneficial for both CPU and GPU memory management.
GPU Classification: A specialized kernel quickly labels each point according to its quadrant. Threads run in parallel for each data point, reducing classification time.
Node Creation: The CPU then subdivides the data into child nodes, en-queuing any child that meets the criteria for further subdivision.

### Parallel Simplification: GPU-Accelerated Douglas-Peucker

Once the QuadTree is built, the Douglas-Peucker (DP) algorithm can be applied in parallel to each region or node. By handling distance computations on the GPU, we harness parallelization of cores to rapidly identify and remove insignificant points.

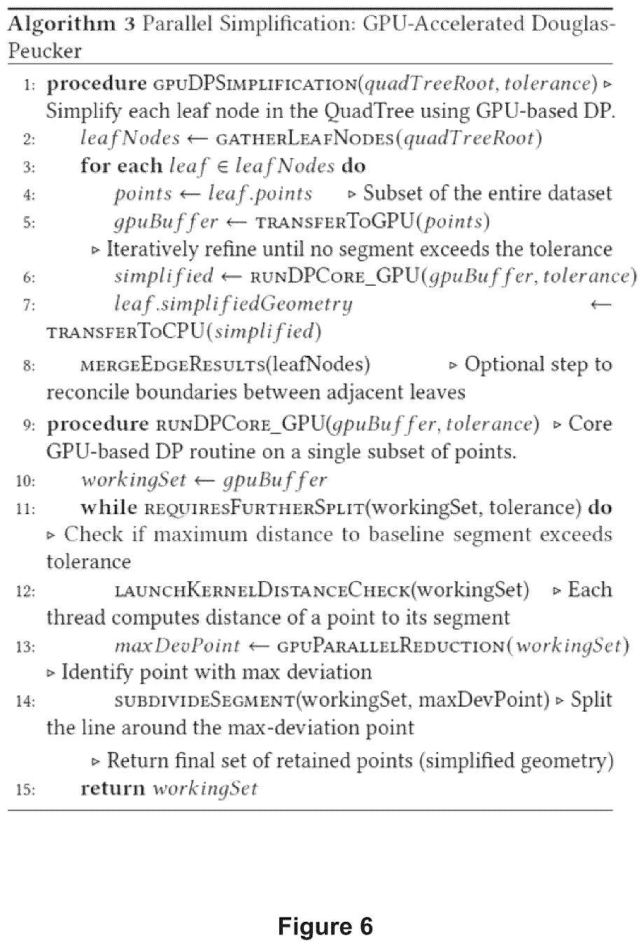

FIG. 6 is an example algorithm for GPU-accelerated point simplification process using the Douglas-Peucker algorithm, in accordance with some embodiments.
(1) Partitioned Data: Each QuadTree leaf or subset typically contains far fewer points than the entire dataset. Processing them in parallel avoids global overhead.
(2) Distance Calculations: A GPU kernel can assign a thread to each point or segment, calculating the perpendicular distance to its bounding line. Points exceeding the threshold remain candidates for further simplification.
(3) Recursive Subdivision (GPU): A parallel reduction can identify the point of maximum deviation, then subdivide the line around that point, recursing until no segment exceeds the threshold.

### ML-Assisted Stopping Criteria

An important part of this adaptive framework is a dynamic analysis of incoming data streams, in which the ML algorithm (e.g., executed by the ML model) monitors the distribution of points in real time. As new data arrives, the model updates its assessment of where clusters, outliers, or trends appear. This awareness helps the system select which points to sample or retain for the Douglas-Peucker (DP) algorithm. In some embodiments, if new clusters arise in the streaming data, the ML engine directs the pipeline to use tighter tolerances, ensuring these important areas retain sufficient detail for accurate visualization. Conversely, in some embodiments, uniform regions with minimal variability are flagged for a higher tolerance, preventing the browser from being overwhelmed by unimportant detail.

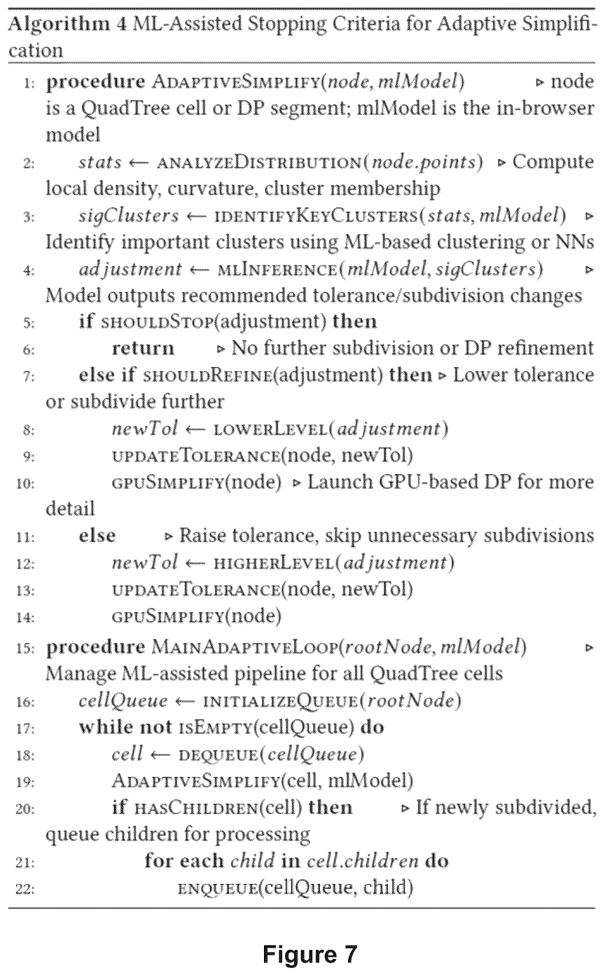

FIG. 7 is an example algorithm showing ML-assisted stopping criteria for adaptive simplification, in accordance with some embodiments.

### Dynamic Data Distribution Analysis

A core function of the ML engine lies in continuously analyzing how data are distributed across the visualization space. This dynamic evaluation identifies meaningful clusters, detects outliers, and marks the most important local patterns. As the browser ingests data, the ML module inspects the statistical profile of each newly formed segment or partition, noting how many points lie within a given neighborhood or how significantly these points deviate from local baselines. This real-time distribution analysis serves as a crucial input when deciding which subsets warrant meticulous processing. The algorithm then feed these insights into the DP routine, adjusting the sampling frequency or threshold parameters on the fly.

### Intelligent Mark Identification and Grouping

Once the ML algorithm understands the data distribution, it identifies key “marks” that should be grouped or preserved. This process leverages clustering methods and simple neural networks to estimate each cluster's significance. Key marks are data marks that are found to be focal points or carry distinct visual or analytic importance. Key marks are explicitly tagged for detailed rendering. This targeted approach forms the foundation of the adaptive simplification scheme, aligning closely with the overarching goal of preserving data accuracy where it matters most.

Examples of key marks include data marks that are located in the middle of the viewport, where the user's focus area should be. These are the marks that are mostly rendered. In contrast, marks that are at the very edge of the viewport may not be the prime importance of the user's focal area and are not rendered at the first instant.

As another example, key marks can be data marks that are more distinguishable. For example, a key mark can be a mark corresponding to a maximum value that is on a different clustering state compared to the rest of the marks. A real-world example can be in the case of sales monitoring. If the average order value is in the $10,000 range and there is an order value that is in millions of dollars, then that is a focal point and is explicitly tagged and rendered.

In large-scale, browser-based data visualization, fixed thresholds for geometry simplification and partitioning often fall short because of the dynamic and heterogeneous nature of the underlying datasets. the disclosed ML-assisted approach directly addresses this shortcoming by continually adjusting the algorithmic tolerances in response to observed data distribution and cluster significance. Where standard pipeline steps rely on static heuristics, the ML component injects situational awareness, ensuring that areas of emerging complexity remain detailed and stable while more homogeneous or less relevant sections remain efficiently aggregated. The net result is a browser application that can handle high data volumes, stream in new updates without overwhelming the user, and sustain an interactive frame rate as the user pans, zooms, or otherwise manipulates the viewport. By selectively directing resources to places where subtle structure exists, the disclosed approaches provide both scalability and high fidelity, culminating in a more robust solution to the challenges laid out in the original problem statement.

### Utilizing Machine Learning for Data Sampling in the DP Algorithm (e.g., Step 116)

In some embodiments, one or more machine learning (ML) algorithms (e.g., executed by machine learning models 1160) are integrated into the data sampling process for the DP algorithm. By leveraging ML techniques directly within the browser, it becomes possible to dynamically analyze data distribution and intelligently identify which data points or data marks need to be grouped or simplified. This approach ensures that the most relevant and significant points are retained for visualization, while redundant or less important points are effectively filtered out.

Dynamic Data Distribution Analysis. In some embodiments, the ML algorithm operates in the browser (e.g., on the client device, such as computing device 1100) to continuously analyze the incoming data stream. It calculates the distribution of the data points, identifying clusters, outliers, and patterns that are crucial for an accurate and meaningful visualization. This real-time analysis allows for a more nuanced understanding of the data, enabling the system to make informed decisions about which points to sample for the DP algorithm.

Intelligent Mark Identification and Grouping. In some embodiments, based on the data distribution analysis, the ML algorithm identifies the marks that should be grouped together. This involves clustering similar data points and determining the significance of each cluster in the context of the overall dataset. By focusing on these key clusters, the algorithm ensures that the most visually and analytically important points are preserved during the simplification process.

Implementing ML in the browser. In some embodiments, to ensure that the ML algorithm runs efficiently in the browser, lightweight models with a customized k-means clustering and simple neural networks are used. These models are optimized for quick execution and low memory usage, making them suitable for real-time data processing in a browser environment. In some embodiments, the ML models are implemented using WebAssembly, which allows for near-native execution speeds in the browser. Additionally, web workers are utilized to run the ML algorithm in parallel with the main rendering process. This parallelization ensures that the data analysis does not interfere with the user interface or the rendering of visualizations.

ML-Assisted Stopping Criteria With a Lightweight Gradient-Boosting Model

The objective of the machine learning model is to predict, for each local data segment, the optimal threshold or subdivision level that balances geometric fidelity with real-time performance. This process begins by accumulating a diverse set of training samples, each consisting of a raw data segment (a collection of points, lines, or polygons) and the corresponding “ideal” local tolerance. The tolerance label is acquired by running multiple fixed thresholds on each segment, measuring the resulting approximation error against a high-precision reference, and selecting the threshold that best reconciles speed and shape quality. Once the training set is assembled, feature engineering transforms each segment into a numeric descriptor vector capturing attributes such as density, average curvature, outlier variance, and prior error distributions. These metrics ensure that regions with complex or noisy geometry receive special attention whereas relatively uniform stretches can tolerate more aggressive simplification. By normalizing these features to a consistent scale, the system accelerates convergence and reduces the likelihood of over fitting.

A lightweight gradient-boosting regressor, scoped down to shallow trees, is trained on these feature vectors and labels. Limiting tree depth ensures a compact model suitable for browser-side inference. Let

$${\{ ( {x}_{i} , {y}_{i} ) \}}_{i = 1}^{n}$$

be the training set, where each feature vector xᵢ∈R^{d} encodes the local geometry (for example, density δ, curvature κ, variance σ), and yᵢ∈R^{d} is the corresponding “ideal” threshold. The training algorithm follows a gradient-boosting approach with a differentiable loss function L(y, F (x)). An initial predictor F₀ is computed by:

$${F}_{0} = arg {min}_{γ} {\sum }_{i = 1}^{n} L ( {y}_{i} , γ ) \qquad ( Equation 1 )$$

Successive rounds add weak learners (shallow regression trees), each fit to pseudo-residuals. At iteration m, the residuals are

$${r}_{i m} = - {[ \frac{\partial ( {y}_{i} , F ( {x}_{i} ) )}{\partial F ( {x}_{i} )} ]}_{F = F m - 1} \qquad ( Equation 2 )$$

where Fₘ₋₁ is the current ensemble. A small regression tree hm of limited depth is trained to predict {rᵢₘ} from xᵢ. The model updates to:

$${F}_{M} ( x ) = {F}_{0} + v {\sum }_{m = 1}^{M} {h}_{m} ( x ) \qquad ( Equation 3 )$$

Next, an ablation study is done to confirm which features are most influential. Removing curvature-based features or variance-related metrics lowers prediction accuracy, while overly large ensembles inflate model size and slow down in-browser inference. The final ensemble remains shallow and small enough to be serialized to a compact JSON file of 139 KB. This compressed packaging enables loading within a browser environment without specialized frameworks. At runtime, each new data segment's feature vector is quickly scored by traversing the shallow trees, yielding an updated threshold for line or polygon simplification. Since each decision tree has only a handful of splits, and the ensemble has limited depth, inference completes at interactive speeds.

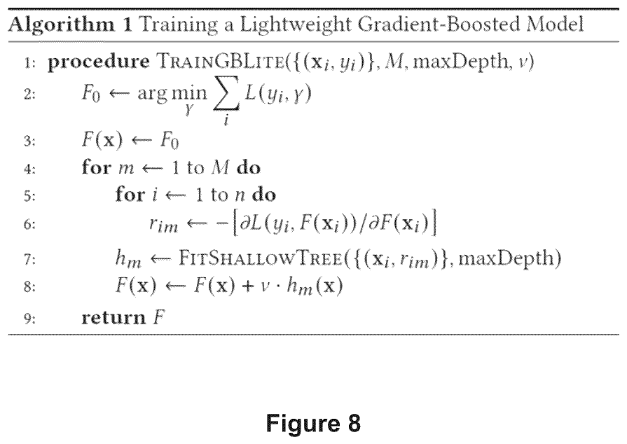

FIG. 8 is an example algorithm of the training process, in accordance with some embodiments.

After validating the model's performance and conducting the ablation study, the final ensemble is exported. During visualization, each segment or node from the QuadTree or Douglas-Peucker pipeline undergoes local feature extraction, the resulting x is passed to the model, and the model outputs a recommended threshold. This adaptive process allows the system to dedicate a low tolerance to complex, high-curvature regions, while data segments with uniform patterns or fewer outliers receive higher tolerances, thus saving computation and memory.

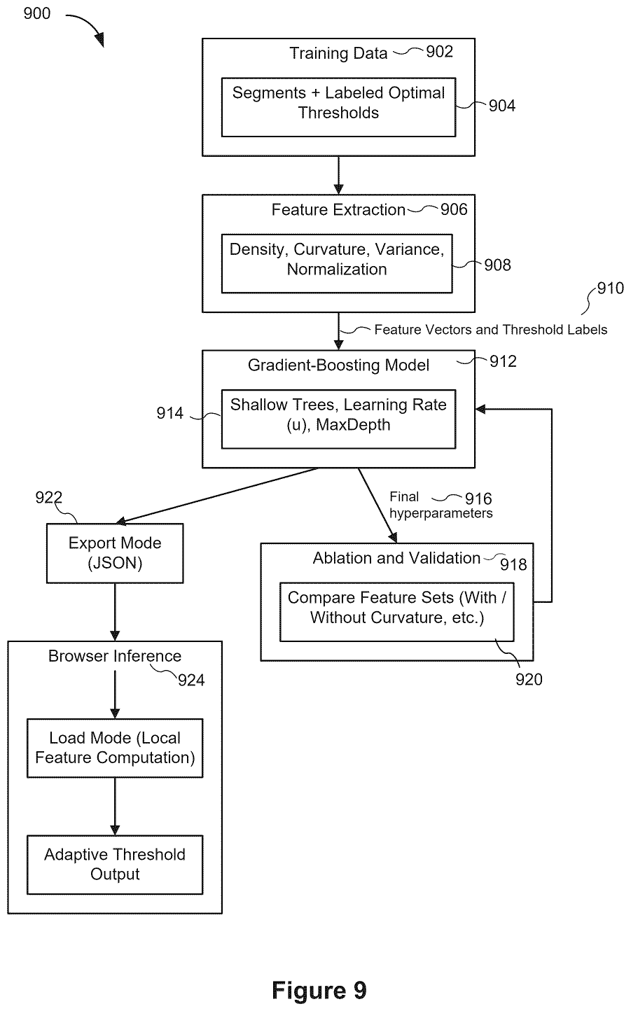

FIG. 9 illustrates a training pipeline 900 for training the ML model, in accordance with some embodiments.

The training data 902 includes raw data segments (a collection of points, lines, or polygons) labeled optimal thresholds (904). Feature extraction (906) is performed on the training data to determine parameters such as the density of the data, curvature of the data, and/or variance of the data. The data is normalized in step 908. Multiple feature vectors with different threshold labels are generated in step 910. The feature vectors with different threshold labels are input into a gradient-boosting model (912). The gradient-boosting model comprises a shallow tree model and MaxDepth is used for the learning rate (914). The final hyperparameters (916) undergo ablation and validation in step 918, where they are compared with feature sets with or without curvature, or with or without density, etc. (step 920). The trained model is exported as a JSON file (922) to the client device (e.g., because the inference has to run on the browser) and deployed for in-browser inference (step 924).

By combining these steps into a single framework, the system achieves a novel, cost-effective learning component that empowers real-time, adaptive stopping criteria for geometric simplification. Its reliance on shallow trees and carefully selected features ensures quick predictions that function seamlessly in web browsers, keeping the overall user experience responsive while preserving crucial details in high-density regions.

As disclosed, a key advantage of the disclosed approaches is that they are not limited to a single chart type or data representation. The enhanced algorithm is designed to handle a broad spectrum of visualizations, including line charts, bar charts, scatter plots, and more. This flexibility stems from the fundamental nature of the underlying strategies, which focus on spatial partitioning and geometric simplification. This flexibility ensures that the benefits of optimized rendering and improved performance can be realized across different use cases and visualization requirements. Regardless of whether the data is continuous or discrete. Whether dealing with continuous data in line charts or discrete data in bar charts, the algorithm adapts to provide efficient and high-fidelity rendering of visualizations.

By combining incremental sampling, CPU-GPU parallelization, dynamic tolerance adjustment, and a well-tuned QuadTree structure, a highly responsive and flexible optimization framework is achieved. These enhancements ensure that even massive datasets can be handled gracefully in the browser, enabling smoother and more powerful data exploration.

### Performance Results

Experimental Setup. All experiments were conducted on a workstation featuring an Intel Core i7-10700 CPU with 32 GB of RAM and an NVIDIA RTX 4080 GPU, running on Windows 10 with Chrome (version 130) as the primary browser. To evaluate scalability, three dataset sizes (1 million, 3 million, and 5 million marks), drawn from real-world geo-spatial traces and artificially generated clusters, were tested.

Comparative Analysis. The proposed GPU+QuadTree+Douglas-Peucker+ML method is compared against several baseline and incremental approaches:
CPU Only: A naive method that renders all points in the browser without any QuadTree or DP simplification.
CPU+Basic QuadTree: A purely CPU-based QuadTree partitioning with fixed thresholds, no DP.
CPU+QuadTree+DP: CPU-based QuadTree partitioning and classical Douglas-Peucker simplification, using a static tolerance.
GPU (Naive): Transfers all points to the GPU for direct plotting, but lacks spatial indexing or simplification.
GPU+QuadTree+DP: Combines GPU-accelerated DP with QuadTree partitioning but still relies on static thresholds.
Proposed Method (GPU+Quad+DP+ML): Incorporates the complete pipeline with ML-driven thresholds, GPU accelerated DP, and an adaptive QuadTree

The results are presented in Table 1, focusing on the 5-million-point dataset for clarity. Larger datasets (10 million or 50 million points) show similar scaling trends but with proportionally higher absolute times and memory footprints.

TABLE 1
Comparative Performance for a 5 million -Point
Dataset (95th Percentile Over 5000 Runs)

| | Memory | Load | Render | CPU | GPU | |
|---|---|---|---|---|---|---|
| Approach | (MB) | (ms) | (ms) | % | % | FPS |
| CPU Only | 600 (12) | 3000 (85) | 5000 (120) | 90 | 0 | 10 |
| CPU + Basic QuadTree 0 25 | 400 (10) | 1500 (40) | 2000 (60) | 85 | 0 | 25 |
| CPU + QuadTree + DP | 300 (8) | 800 (25) | 1500 (40) | 71 | 0 | 30 |
| GPU (Naive) | 350 (7) | 600 (15) | 700 (20) | 55 | 40 | 45 |
| GPU + QuadTree + DP | 200 (6) | 400 (10) | 200 (8) | 49 | 55 | 55 |
| Proposed Method (GPU + | 132 (5) | 300 (12) | 50 (3) | 40 | 70 | 60 |
| Quad + DP + ML) | | | | | | |

### Key Findings

From the data in Table 1, the Proposed Method achieves substantial improvements over simpler or naive approaches:

Memory Reduction: Memory usage drops to about 132 MB from a baseline of 600 MB, a reduction of approximately 78%. This gain is primarily attributed to the adaptive QuadTree partitioning, which avoids loading and retaining unnecessary points, along with incremental ML-based simplifications.

Rendering Time: The final visualization appears in roughly 50 ms, which is a 99% decrease compared to the naive CPU method's 5000 ms. By distributing geometric calculations to the GPU and only refining crucial areas, time spent on redundant or low-importance points is minimized

Load Time: The time to display the first plots shrinks from 3000 ms to 300 ms (a 90% improvement), reflecting a reduction in the volume of data transmitted and processed up front, plus the immediate offloading of tasks to Web Workers and the GPU.

Interactive FPS: In all GPU-based methods, frame rates improve, but the ML-driven approach sees the highest average FPS (60), indicating smoother panning and zooming. By dynamically halting refinement in areas deemed uninteresting, the system frees resources for critical rendering tasks.

Comparative Benchmark with Other Summarization Techniques

A further dimension of the evaluation involved comparing the rendering time and peak memory usage of the proposed pipeline against alternative summarization algorithms that are commonly employed for large-scale 2D data aggregation. Specifically, benchmarks were made against hexagonal binning and Voronoi tesselations, both of which have been used extensively in geospatial and statistical applications to reduce visual clutter. For both hexagonal binning and Voronoi tessellation, we tested implementations optimized forWebAssembly in the browser, while the GPU performed parallel computations for the tesselation or binning steps.

Table 2 summarizes the results for three dataset sizes (3 million, 10 million, and 50 million points), contrasting average render times and peak memory consumption across the three techniques.

TABLE 2
Comparison of Render Time and Memory Usage
for Different Summarization Techniques (3
million, 10 million, 50 million Points).

| | Render time (ms) | | | Memory (MB) | | |
|---|---|---|---|---|---|---|
| Technique | 3M | 10M | 50M | 3M | 10M | 50M |
| Hex Binning | 800 | 1500 | 6000 | 300 | 700 | 3500 |
| Voronoi Tessellation | 1200 | 2800 | 9000 | 400 | 1200 | 2800 |
| Proposed (GPU + Quad + | 400 | 900 | 3000 | 180 | 400 | 670 |
| DP + ML) | | | | | | |

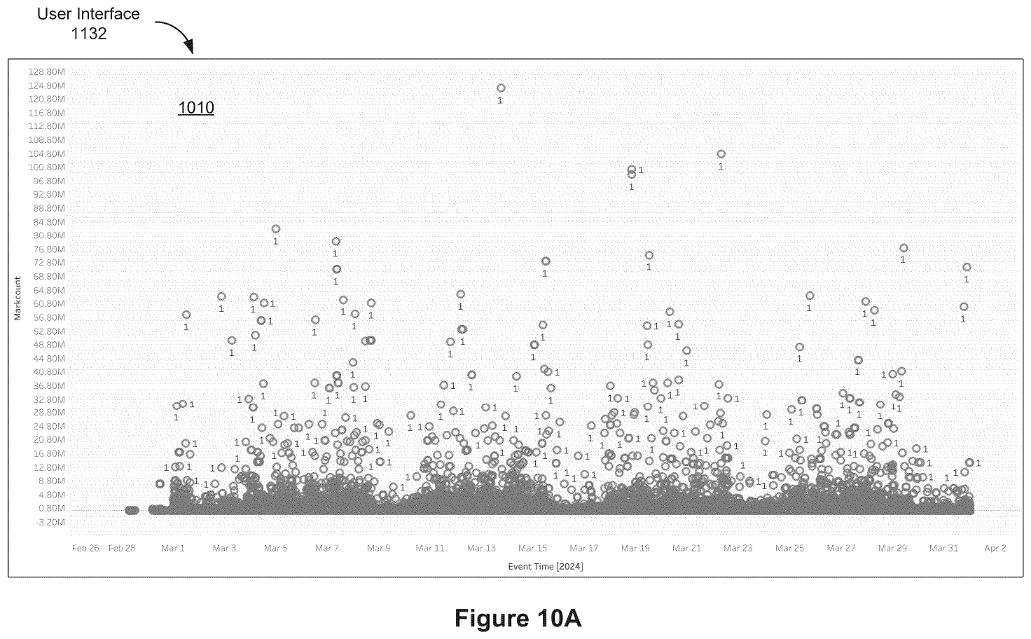

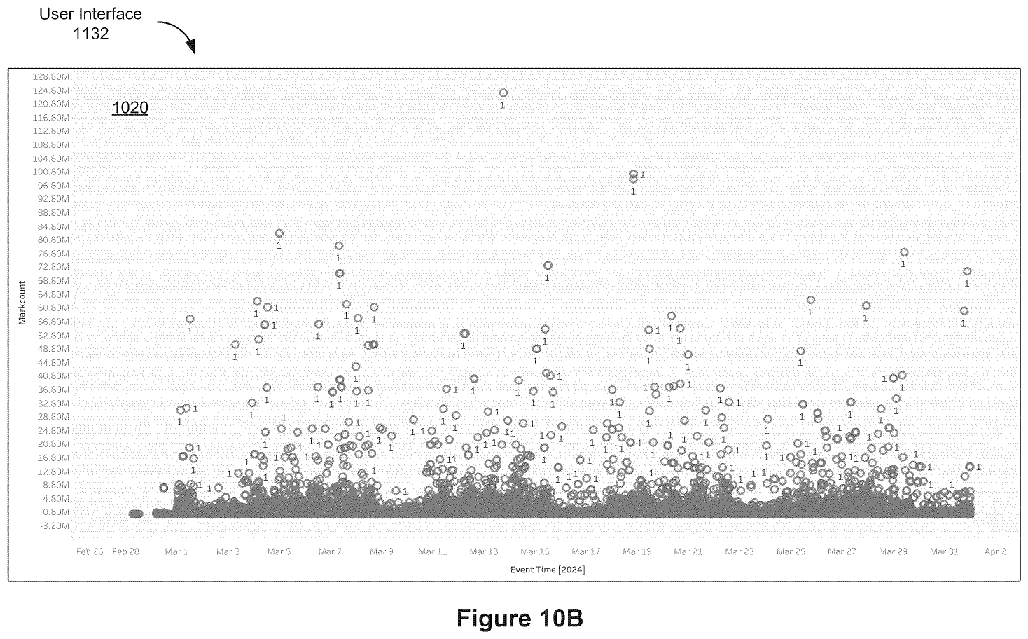

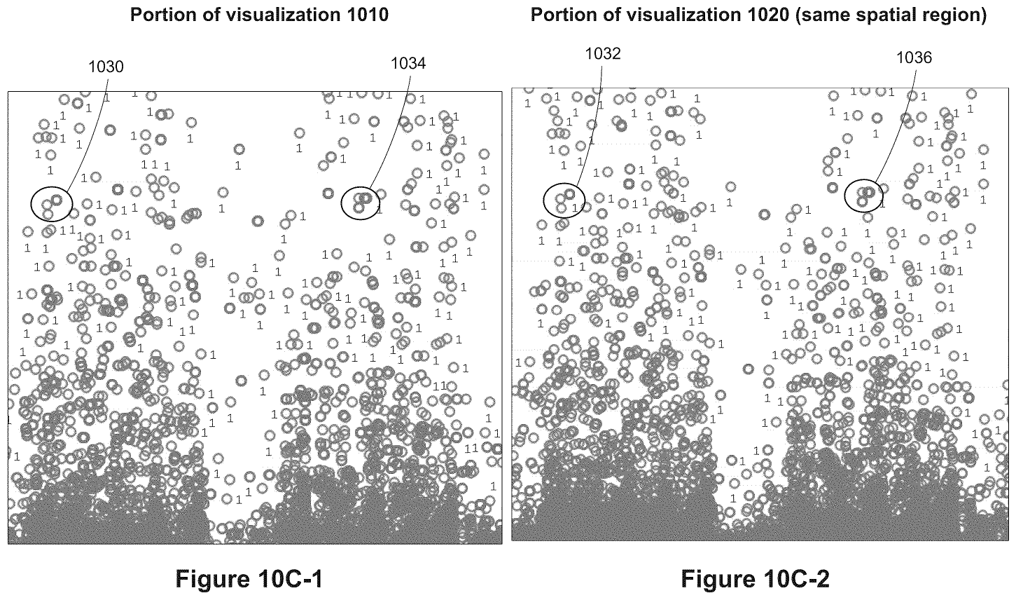

FIG. 10A illustrates a rendered data visualization 1010 that is displayed in a user interface 1132 of a computing device (e.g., computing device 1100), in accordance with some embodiments. In this example, the data visualization 1010 is rendered using all data points of a dataset. The total number of data marks in the data visualization 1010 is 19,342,787 (˜19.4 million).

FIG. 10B illustrates a data visualization 1020 that is rendered using a reduced number of data points of the same dataset that is used to render the data visualization 1010. In this example, the data visualization 1020 is rendered using 2,011,030 (˜2 million) data points. Even though the data visualization 1020 uses only about 10% of the total number of data points in the dataset, the user's visual perception of the data visualization is not impacted.

FIG. 10C-1 shows a portion of data visualization 1010. FIG. 10C-2 shows a portion of data visualization 1020 from approximately the same spatial area. Even though data visualization 1020 has fewer data marks compared to data visualization 1010, the perceived appearance change of the visualization is minimally impacted. For example, data visualization 1010 includes a cluster 1030 of data marks, where the top right mark appears to have a thicker outline due to the presence of overlapping marks in that region. FIG. 10C-2 illustrates data visualization 1020 includes a similar cluster 1032 of data marks with the same visual appearance. A similar situation applies for the cluster 1034 of data marks in the data visualization 1010 and the cluster 1036 of data marks in the data visualization 1020.

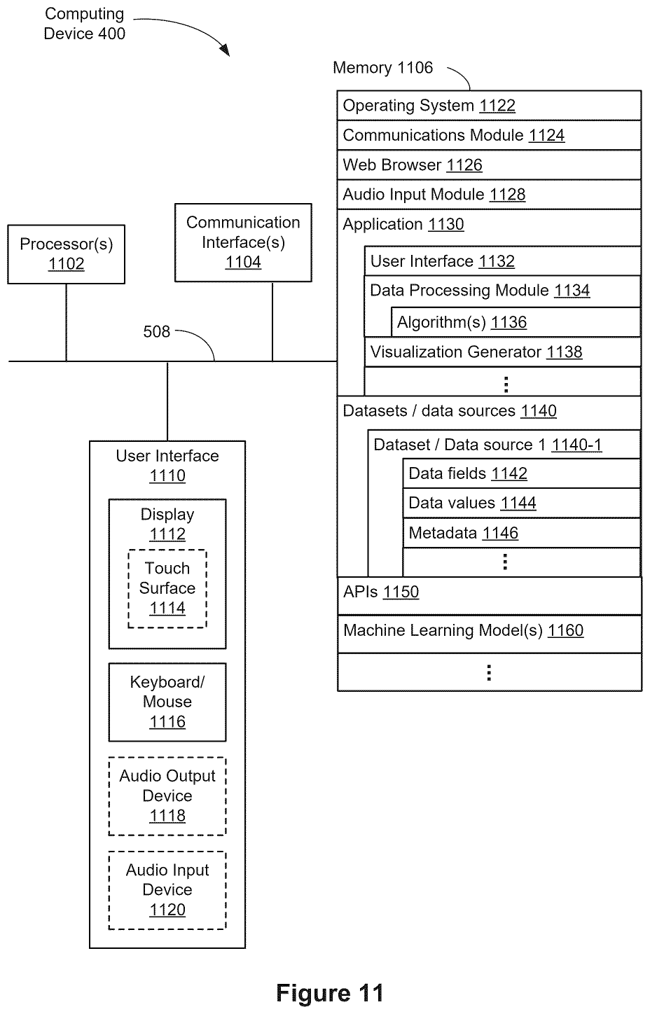

FIG. 11 is a block diagram of a computing device 1100 for visualizing large datasets, in accordance with some embodiments. Various examples of the computing device 1100 include a desktop computer, a laptop computer, a tablet computer, and other computing devices that have a display and a processor capable of running an application 1130. The computing device 1100 typically includes one or more processors (processing units or cores) 1102, one or more network or other communication interfaces 1104, memory 1106, and one or more communication buses 1108 for interconnecting these components. In some embodiments, the communication buses 1108 include circuitry (sometimes called a chipset) that interconnects and controls communications between system components.

In some embodiments, the one or more processors 1102 comprise a plurality of processors corresponding to a plurality of processor types. In some embodiments, the processor types include one or more of: a central processing unit (CPU) and a graphics processing unit (GPU). In some embodiments, the processor types include an integrated graphics processing (iGPU), a general-purpose graphics processing unit (iGPU), and a tensor processing unit (TPU).

The computing device 1100 includes a user interface 1132. The user interface 1110 typically includes a display device 1112. In some embodiments, the computing device 1100 includes input devices such as a keyboard, mouse, and/or other input buttons 1116. Alternatively or in addition, in some embodiments, the display device 1112 includes a touch-sensitive surface 1114, in which case the display device 1112 is a touch-sensitive display. In some embodiments, the touch-sensitive surface 1114 is configured to detect various swipe gestures (e.g., continuous gestures in vertical and/or horizontal directions) and/or other gestures (e.g., single/double tap). In computing devices that have a touch-sensitive display 1114, a physical keyboard is optional (e.g., a soft keyboard may be displayed when keyboard entry is needed). The user interface 1110 also includes an audio output device 1118, such as speakers or an audio output connection connected to speakers, earphones, or headphones. Furthermore, some computing devices 1100 use a microphone and voice recognition to supplement or replace the keyboard. In some embodiments, the computing device 1100 includes an audio input device 1120 (e.g., a microphone) to capture audio (e.g., speech from a user).

In some embodiments, the memory 1106 includes high-speed random-access memory, such as DRAM, SRAM, DDR RAM, or other random-access solid-state memory devices. In some embodiments, the memory 1106 includes non-volatile memory, such as one or more magnetic disk storage devices, optical disk storage devices, flash memory devices, or other non-volatile solid-state storage devices. In some embodiments, the memory 1106 includes one or more storage devices remotely located from the processors 1102. The memory 1106, or alternatively the non-volatile memory devices within the memory 1106, includes a non-transitory computer-readable storage medium. In some embodiments, the memory 1106, or the computer-readable storage medium of the memory 1106, stores the following programs, modules, and data structures, or a subset or superset thereof:
an operating system 1122, which includes procedures for handling various basic system services and for performing hardware dependent tasks;
a communications module 1124, which is used for connecting the computing device 1100 to other computers (e.g., server 1200) and devices via the one or more communication interfaces 1104 (wired or wireless), such as the Internet, other wide area networks, local area networks, metropolitan area networks, and so on;
a web browser 1126 (or other application capable of displaying web pages), which enables a user to communicate over a network with remote computers or devices;
an audio input module 1128 (e.g., a microphone module), which processes audio captured by the audio input device 1120. The captured audio may be sent to a remote server (e.g., a server system 1200) and/or processed by an application executing on the computing device 1100 (e.g., the application 1130);
an application 1130 for optimizing the number of data points datasets that are used to render data visualizations. In some embodiments, the application 1130 is a browser-based application, meaning that it operates entirely within a web browser (e.g., web browser 1126) environment. In some embodiments, the application 1130 is an application that is installed on and executes on the computing device. In some embodiments, the application 1130 includes:
   a user interface 1132 displaying rendered (e.g., generated) data visualizations and for a user to interact with the data visualizations;
   a data processing module 1134, for optimizing the rendering visualizations of datasets (e.g., datasets/data sources 1140). In some embodiments, a dataset can include at least 100,000 data points, 500,000 data points, 1 million data points, 5 million data points, 10 million data points, 50 million, or 100 million data points In some embodiments, the data processing module 1134 applies algorithm(s) 1136 to reduce the number of data points in the dataset and at the same time, preserve the visual perception of the data visualization (e.g., as illustrated in FIGS. 10A, 10B, and 10C). In some embodiments, the algorithm(s) 1136 comprise point simplification algorithms. For example, the algorithm(s) 1136 can include the Douglas-Peucker (DP) algorithm, the Visvalingam-Whyatt (VW) algorithm, and/or enhanced forms of these algorithms that allow for incremental sampling and simplification, parallelization, dynamic runtime tolerance, and broad applicability across different types of visualizations. In some embodiments, the data processing module 1134 performs initial data cleaning and transformation tasks, feature extraction, segmentation, and batching, as discussed with respect to the “Client-Side Data Preprocessor” section. In some embodiments, the algorithm(s) 1136 comprise ML algorithms executed by ML models 1160; and
   a visualization generator 1138 for generating and displaying data visualizations;
zero or more datasets or data sources 1140, which are used by the application 1130, and/or the machine learning models 1160. In some embodiments, the datasets/data sources 1140 include a first dataset or a first data source (e.g., dataset/data source 1 11140-1). In some embodiments, a respective dataset or data source 1140 includes data fields 1142, data values 1144 (e.g., data points) corresponding to the data fields, and metadata 1146 of the data fields and/or data values. In some embodiments, the computing device 1100 stores each data point of a dataset in a quadtree data structure format;
APIs 1150 for receiving API calls from one or more applications (e.g., a web browser 1126, application 1130, or machine learning model(s) 1160), translating the API calls into appropriate actions, and performing one or more actions; and
one or more machine learning models 1160, which executes one or more machine learning algorithms for data sampling. In some embodiments, the machine learning models 1160 include a trained machine learning model that is configured to guide the stopping criteria in both QuadTree construction and DP simplification. See, e.g., sections on “Dynamic Runtime Tolerance,” “ML-Assisted Stopping Criteria,” and “ML-Assisted Stopping Criteria With a Lightweight Gradient-Boosting Model.” In some embodiments, the trained model is exported by the server 1200 to the computing device 1100 as a JSON file and deployed for in-browser inference. In some embodiments, the machine learning models 1160 are configured to determine respective distributions of data points and identify clusters, outliers, and patterns that are crucial for an accurate and meaningful visualization.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 1106 stores a subset of the modules and data structures identified above. Furthermore, the memory 1106 may store additional modules or data structures not described above. In some embodiments, a subset of the programs, modules, and/or data stored in the memory 1106 is stored on and/or executed by a server system 1200.

Although FIG. 11 shows a computing device 1100, FIG. 11 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 1100 may be stored or executed on a server system 1200.

In various implementations, the models (e.g., machine learning models 1160) and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

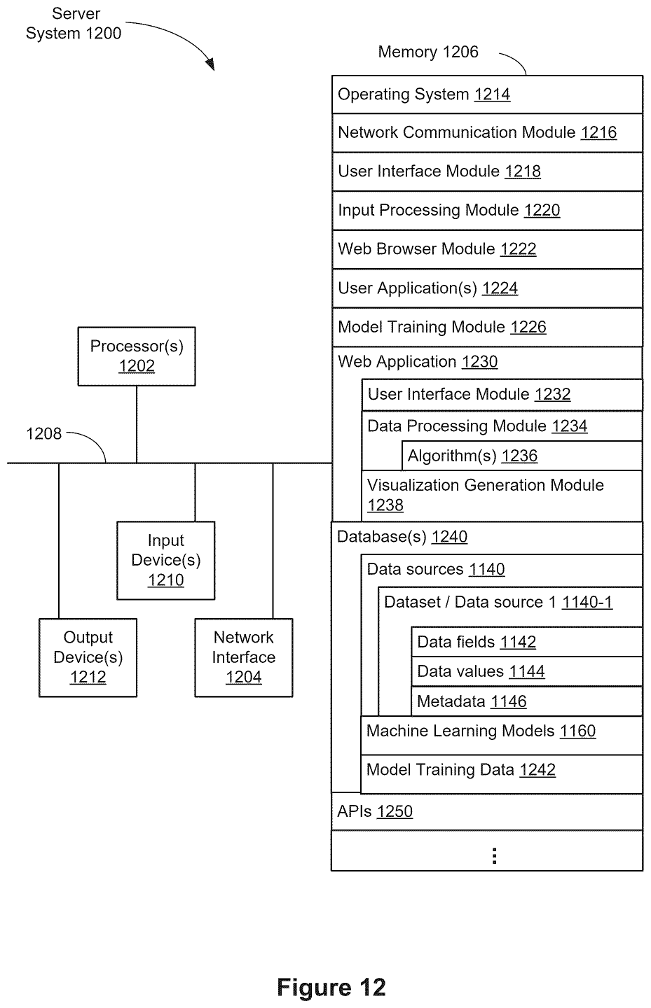

FIG. 12 is a block diagram of a server system 1200 (e.g., computer system), in accordance with some embodiments. Examples of the server 1200 include, but are not limited to, a server computer, a desktop computer, a laptop computer, a tablet computer, or a mobile phone. The server 1200 typically includes one or more processors 1202, one or more network interfaces 1204, memory 1206, and one or more communication buses 1208 for interconnecting these components (sometimes called a chipset).

In some embodiments, the one or more processors 1202 comprise a plurality of processing units corresponding to a plurality of processor types. In some embodiments, the processor types include one or more of: a central processing unit (CPU) and a graphics processing unit (GPU). In some embodiments, the processor types include an integrated graphics processing (iGPU), a general-purpose graphics processing unit (iGPU), and a tensor processing unit (TPU).

The server 1200 includes one or more user interface devices. The user interface devices include one or more input devices 1210, which facilitate user input, such as a keyboard, a mouse, a voice-command input unit or microphone, a touch screen display, a touch-sensitive input pad, a gesture capturing camera, or other input buttons or controls. Furthermore, in some embodiments, the server 1200 uses a microphone and voice recognition or a camera and gesture recognition to supplement or replace the keyboard. In some embodiments, the one or more input devices 1210 include one or more cameras, scanners, or photo sensor units for capturing images, for example, of graphic serial codes printed on electronic devices. The server 1200 also includes one or more output devices 1212, which enable presentation of user interfaces and display content, including one or more speakers and/or one or more visual displays. The server system 1200 typically includes one or more processors 1202, one or more network interfaces 1204, memory 1206, and one or more communication buses 1208 for interconnecting these components. In some embodiments, the communication buses 1208 include circuitry (sometimes called a chipset) that interconnects and controls communications between system components.

The memory 1206 includes high-speed random access memory, such as DRAM, SRAM, DDR RAM, or other random access solid state memory devices. In some embodiments, the memory includes non-volatile memory, such as one or more magnetic disk storage devices, one or more optical disk storage devices, one or more flash memory devices, or one or more other non-volatile solid state storage devices. In some embodiments, the memory 1206 includes one or more storage devices remotely located from one or more processors 1202. The memory 1206, or alternatively the non-volatile memory within memory 1206, includes a non-transitory computer readable storage medium. In some embodiments, the memory 1206, or the non-transitory computer readable storage medium of the memory 1206, stores the following programs, modules, and data structures, or a subset or superset thereof:
an operating system 1214, which includes procedures for handling various basic system services and for performing hardware dependent tasks;
a network communication module 1216, which connects the server 1200 to other devices (e.g., computing device(s) 1100 and/or other servers 1200) via one or more network interfaces (wired or wireless) and one or more communication networks, such as the Internet, other wide area networks, local area networks, metropolitan area networks, and so on;
a user interface module 1218, which enables presentation of information (e.g., a graphical user interface for user application 1224, web application 1230, widgets, websites and web pages thereof, audio content, and/or video content) at the computing device 1100 via one or more output devices 1212 (e.g., displays or speakers);
an input processing module 1220, which detects one or more user inputs or interactions from one of the one or more input devices 1210 and interprets the detected input or interaction;
a web browser module 1222, which navigates, requests (e.g., via HTTP), and displays websites and web pages thereof, including a web interface for logging into a user account of a user application 1224;
one or more user applications 1224, which are executed at the server 1200;
a model training module 1226, for training one or more machine learning models 1160;
a web application 1230 for optimizing the number of data points datasets that are used to render data visualizations, which may be downloaded and executed by a web browser 1126 on a user's computing device 1100. In general, a web application 1230 has the same functionality as a desktop application 1130, but provides the flexibility of access from any device at any location with network connectivity, and does not require installation and maintenance. In some embodiments, the web application 1130 includes various software modules to perform certain tasks, such as:
   a user interface module 1232, which provides the user interface for all aspects of the web application 1230;
   a data processing module 1234, which has the same functionalities as the data processing module 1134; and
   an algorithm 1236, which has the same functionalities as the algorithm 1136;
In some embodiments, the server system 1200 includes a database 1240. In some embodiments, the database 1240 includes zero or more datasets or data sources 1140, which are used by the user application(s) 1224, web application 1230, and model training module 1226, and machine learning models 1160. In some embodiments, the datasets/data sources 1140 include a first dataset or a first data source (e.g., dataset/data source 1 1140-1). In some embodiments, a respective dataset or data source 1140 includes data fields 1142, data values 1144 (e.g., data points) corresponding to the data fields, and metadata 1146 of the data fields and/or data values. In some embodiments, the database 1240 stores machine learning models 1160.

In some embodiments, the memory 1206 stores APIs 1250 for receiving API calls from one or more applications (e.g., user application(s) 1224, web application 1230, and/or model training module 1226), translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 1206 stores a subset of the modules and data structures identified above. Furthermore, the memory 1206 may store additional modules or data structures not described above.

Although FIG. 12 shows a server system 1200, FIG. 12 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 1200 may be stored or executed on a computing device 1100. In some embodiments, the functionality and/or data may be allocated between a computing device 1100 and one or more servers 1200. Furthermore, one of skill in the art recognizes that FIG. 12 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

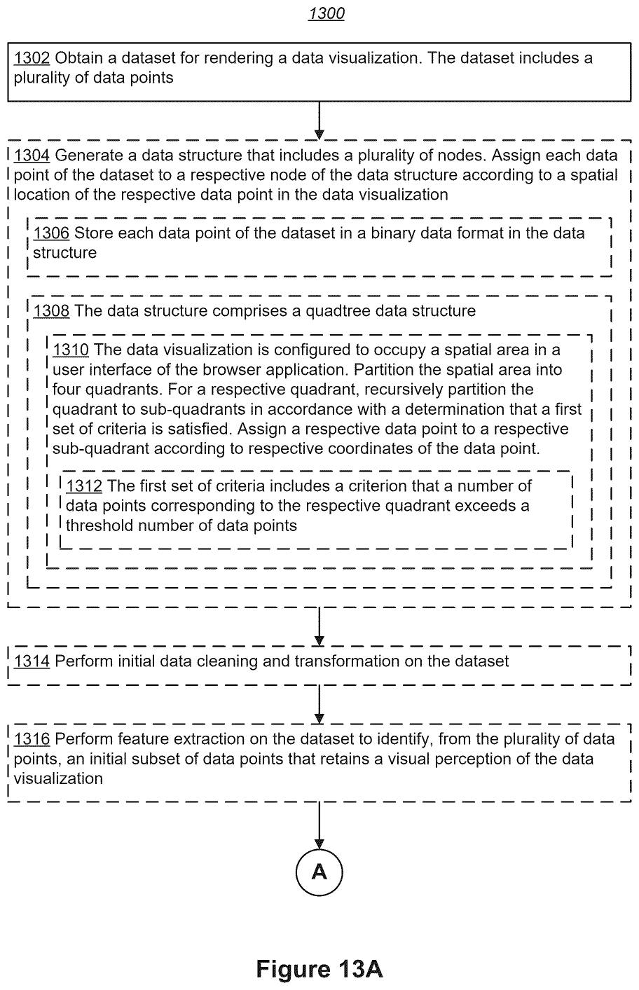

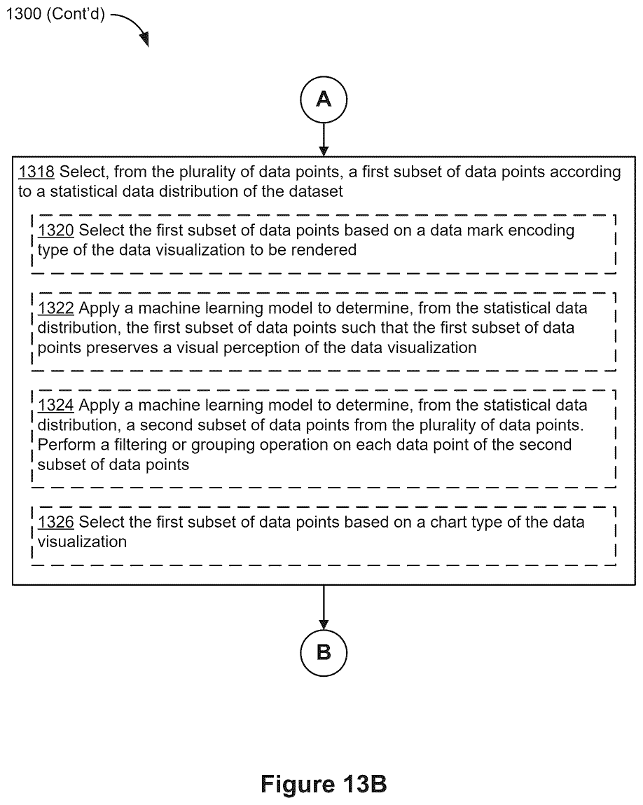

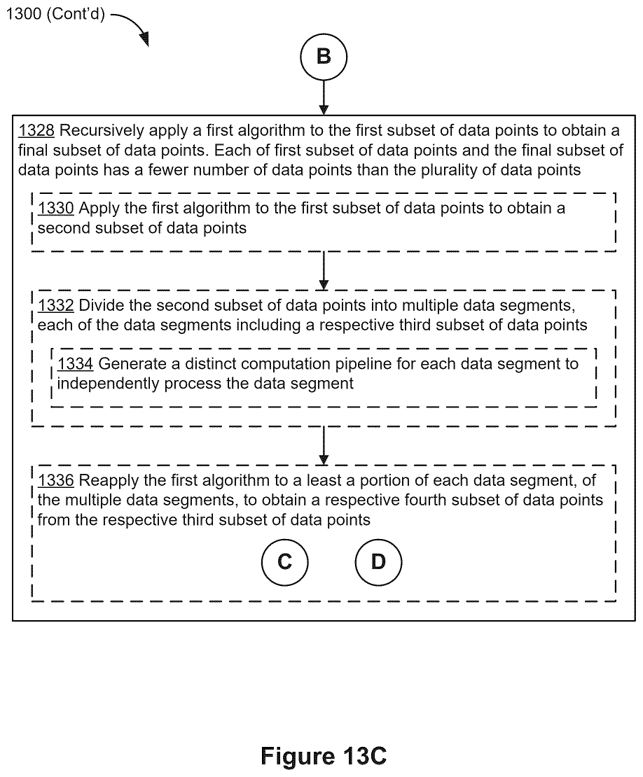

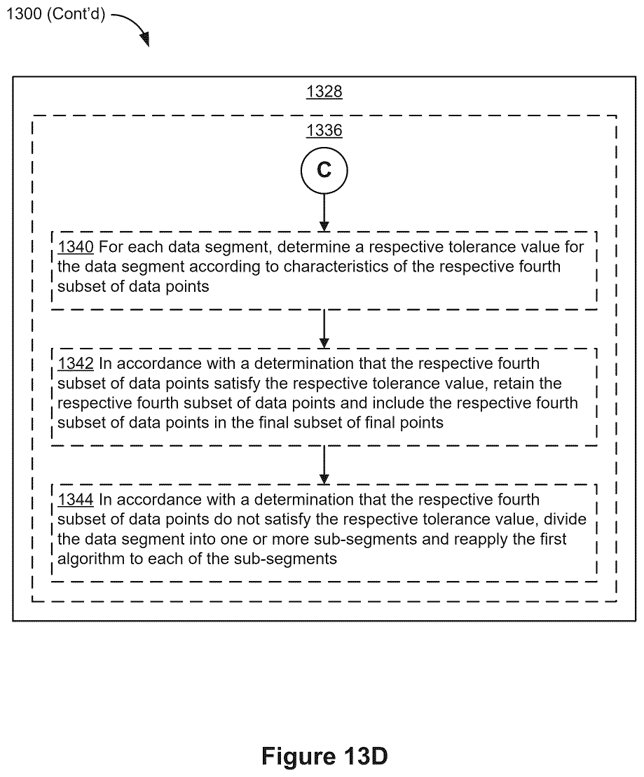

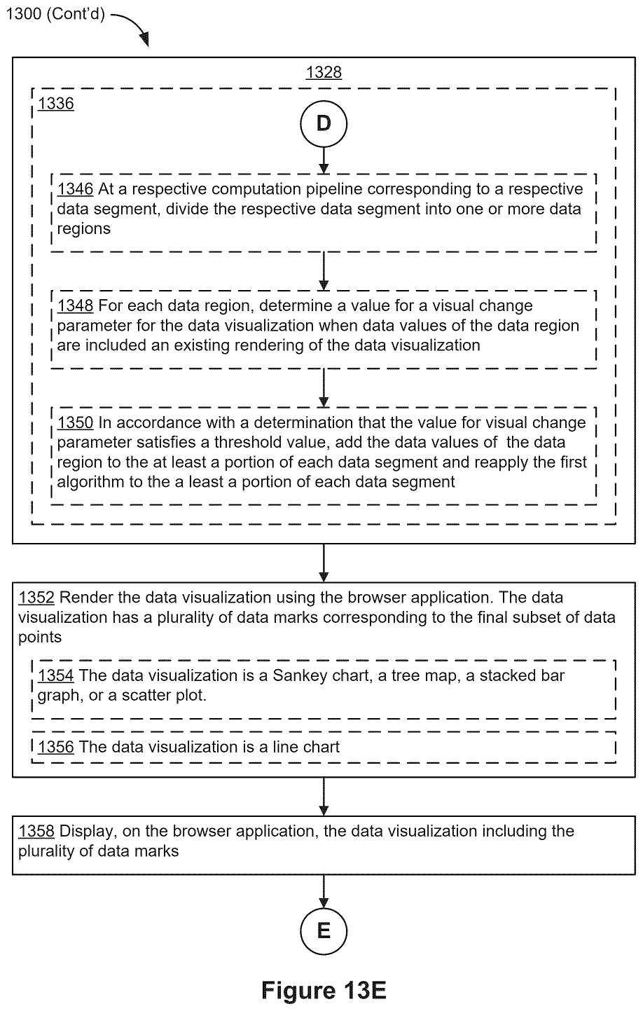

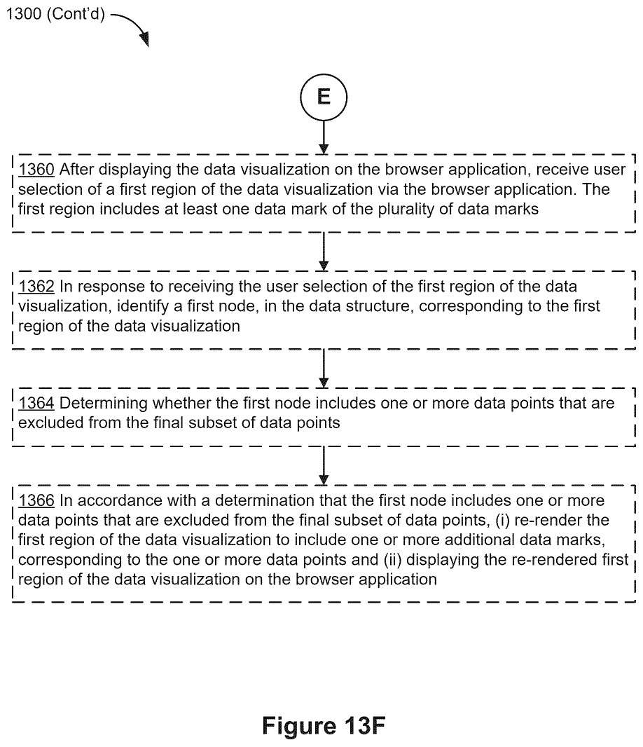

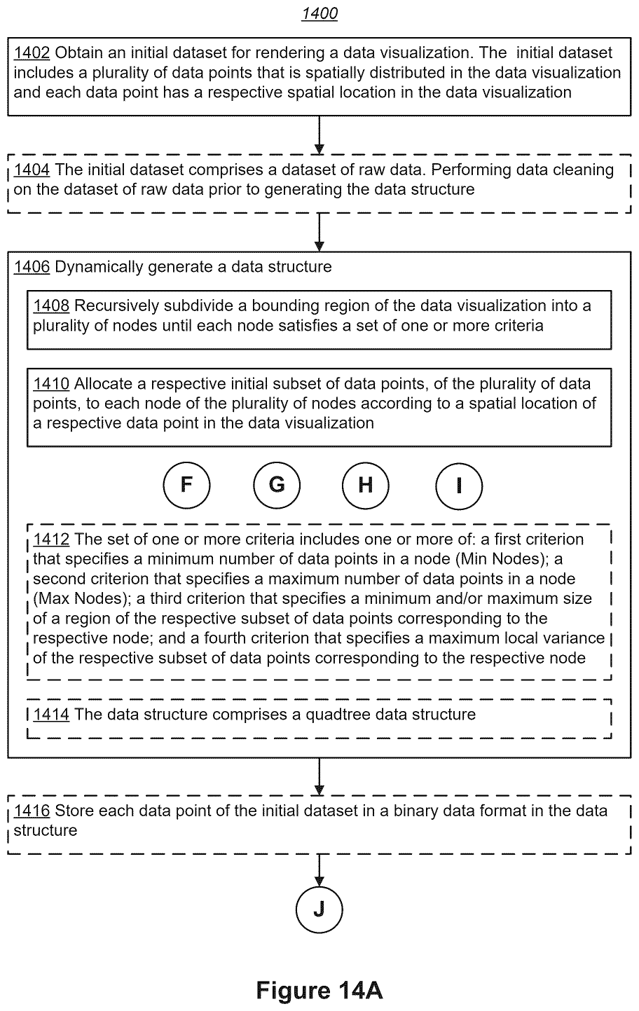

FIGS. 13A to 13F provide a flowchart of an example process for visualizing large datasets, in accordance with some embodiments. The method 1300 is performed at a computing device (e.g., computing device 1100) executing a browser application (e.g., application 1130). The computing device includes one or more processors (e.g., processor(s) 1102) and memory (e.g., memory 1106). In some embodiments, the memory stores one or more programs or instructions configured for execution by the one or more processors. In some embodiments, the operations shown in FIGS. 1, 2, 3A, 3B, 4, 5, 6, 7, 8, 9, and 10A-10C correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1300 may be combined with the method 1400, and/or the order of some operations may be changed.

The computing device obtains (1302) a dataset for rendering a data visualization, the dataset including a plurality of data points (e.g., data values). In some embodiments, the plurality of data points comprises at least 100,000 data points, 500,000 data points, 1 million data points, 5 million data points, 10 million data points, 50 million, or 100 million data points.

In some embodiments, the computing device, after obtaining the dataset, generates (1304) a data structure that includes a plurality of nodes. The computing device assigns each data point, of the plurality of data points of the dataset, to a respective node of the data structure according to a spatial location (e.g., spatial coordinates) of the respective data point in the data visualization.

In some embodiments, the computing device stores (1306) each data point of the dataset in a binary data format in the data structure.

In some embodiments, the data structure comprises (1308) a quadtree data structure.

In some embodiments, the data visualization occupies (1310) a spatial area (e.g., two-dimensional space) in a user interface (e.g., user interface 1132) of the browser application. The computing device partitions the spatial area into four quadrants (each quadrant corresponding to a respective sub-area of the data visualization). For a respective quadrant, the computing device recursively partitions the quadrant to sub-quadrants in accordance with a determination that a first set of criteria (e.g., one or more criteria) is satisfied. The computing device assigns a respective data point to a respective sub-quadrant according to respective coordinates of the data point.

In some embodiments, the first set of criteria includes (1312) a criterion that a number of data points corresponding to the respective quadrant exceeds a threshold number of data points.

In some embodiments, after obtaining the dataset (and prior to selecting a first subset of data points), the computing device performs client-side data pre-processing. For example, in some embodiments, the computing device performs (1314) (e.g., via data processing module 1134) initial data cleaning and transformation. This can include handling missing values, filtering outliers, normalizing data, and converting data types. In some embodiments, pre-processing ensures that the data is in the best possible shape for rendering, reducing the likelihood of errors and inconsistencies.

In some embodiments, the computing device perform (1316) (e.g., via data processing module 1134) feature extraction on the dataset to identify, from the plurality of data points, an initial subset of data points that retains a visual perception of the data visualization.

Referring to FIG. 13B, the computing device selects (1318) (e.g., samples), from the plurality of data points, a first subset of data points according to a statistical data distribution of the dataset.

In some embodiments, the computing device selects the first subset of data points according to characteristics of the statistical data distribution characteristics.

For example, the characteristics of the data distribution that influence whether or not to select a data point can include an occurrence of null values or zero values in the dataset. In some embodiments, the computing device 1100 (or the server 1200) calculates the sparsity and spread or null values or zero values in the dataset. A null value indicates that a value does not exist (or is unknown) whereas a zero value indicates the data value is zero. In some embodiments, the null/zero values are the first candidates for removal (i.e., not selected or included in the first subset of data points). The calculations for null values are defined as:
Proportion of Null Values per Feature::In each column of the dataset

$$Pnull , j = Total number of entries in feature j / Number of null values in feature j$$

Spread of Null values:

$$Mean , {μ}_{null} = \frac{1}{M} {\sum }_{j = 1}^{M} {P}_{null , j} \qquad ( Equation 4 )$$

$$Variance , {σ}_{n u l l}^{2} \frac{1}{M} {\sum }_{j = 1}^{M} {( {P}_{null , j} - {μ}_{n u l l} )}^{2} \qquad ( Equation 5 )$$

$$Standard Deviation , {σ}_{null} = \sqrt{{σ}_{n u l l}^{2}} \qquad ( Equation 6 )$$

Similar definitions apply in the case of spread of zero values. In some embodiments, the computations are pre-processed at the computing device 1100. In some embodiments, the computations are pre-processed at the server 1200.

As another example, the characteristics of the data distribution that influence whether or not to select a data point can include a frequency of occurrence of a set of values within a specific partition/region of the data visualization to be rendered based on the data. For example, in some embodiments, the computing device 1100 (or the server 1200) can separate the data into partitions or regions (e.g., according to the spatial position of the data in the data visualization), and the frequency of occurrence of a set of values within a specific partition/region (e.g., radius) is determined. This is an iterative method where the objective is to find a data point and determine how many values fall within a specific range of that data point to minimize human perceptive difference in charts.

In yet another example, the characteristics of the data distribution that influence whether or not to select a data point can include a distance between two data marks in a “densely populated” region of a visualization (e.g., distance calculation for each dense region from above step). For example, if a region has 100 marks and the distance between a random mark A and a random mark B is 5 pixels (˜1.3 mm) with a P99 of 2 mm, then all marks below 2 mm (9 pixels) is dropped from the initial rendering. However, these are kept in memory to flash render if the user zooms in a particular zone in the chart.

Another characteristic of the data is the viewport and rendering sequence based on high spread and freshness. When the data has latest values (if grouped by time or new upserts), these data points are given first priority to render and subsequent rendering happens on descending sorted order of values. Similarly for viewport, only the rendering happens within the viewport which is visible to user based on screen size. Dense data regions are calculated for the entire dataset that needs to be rendered. The priority of rendering is given first to less dense regions and very dense regions of data is rendered at the end.

In some embodiments, the subset of data points are selected at regular intervals (e.g., sampling rate), such as one out of every three data points, or one out of every five data points).

With continued reference to FIG. 13B, in some embodiments, the computing device selects (1320) the subset of data points based on a data mark encoding type of the data visualization to be rendered. (e.g., a shape of the encoding, whether the data mark encoding comprises an open circle such as those in the examples of FIGS. 10A, 10B, and 10C, or whether the data marks comprise solid fill.) Using FIGS. 10C-1 and 10C-2 as an example, suppose the clusters 1030 and 1032 comprise data marks that are encoded with a solid fill, the computing device may be able to remove some of the overlapping data marks (e.g., data points) located at the top right corner of the cluster 1032, because the change in appearance will not be apparent whether there is one data mark with a solid fill or two data marks with solid fill that completely overlap each other.

In some embodiments, the computing device selects the first subset of data points by applying (1324) a machine learning model (e.g., machine learning models 1160) to determine, from the data distribution (e.g., in real time), the first subset of (e.g., one or more) data points such that the first subset of data points preserves a visual perception of the data visualization. For example, in some embodiments, the machine learning model can execute an algorithm that calculates the distribution of the data points and identifies clusters, outliers, and patterns that are crucial for an accurate and meaningful visualization.

In some embodiments, the computing device applies (1324) a machine learning model (e.g., machine learning model(s) 1160) to determine, from the data distribution, a second subset of data points (e.g., one or more data points) from the plurality of data points, and performs a filtering or grouping operation on each data point in the second subset of data points.

In some embodiments, the computing device selects the subset of data points based on a chart type of the data visualization to be rendered.

The computing device recursively applies (1328) a first algorithm (e.g., DP algorithm or VW algorithm) to the first subset of data points to obtain a final subset of data points. Each of first subset of data points and the final subset of data points has a fewer number of data points than the plurality of data points.

In some embodiments, the final subset of data points includes a data point that is present in the first subset of data points.

In some embodiments, recursively applying the first algorithm to the first subset of data points to obtain the final subset of data points includes applying (1330) the first algorithm to the first subset of data points to obtain a second subset of data points (e.g., by selecting, from the first subset of data points, the more significant points and discarding the less significant ones based on a tolerance level), and dividing (1332) the second subset of data points into multiple (e.g., non-overlapping) data segments, each of the data segments including a respective third subset of data points.

In some embodiments, the computing device generates (1334) (e.g., spawns, implements, or executes) a distinct computation pipeline (e.g., web worker) for each data segment, of the multiple segments, to independently process the segment. In some embodiments, recursively applying the first algorithm to the first subset of data points to obtain the final subset of data points includes reapplying (1336) the first algorithm to a least a portion of each data segment, of the multiple data segments, to obtain a respective fourth subset of data points from the respective third subset of data points. The number of data points in the fourth subset is fewer than the number of data points in the third subset.

In some embodiments, when performing incremental simplification on each data segment, the first algorithm works only on the reduced dataset based on the first subset of data. However, the original data points are kept in memory and once the first phase of rendering is complete with all sampled data, a set of web workers add the original marks so as to give a complete visualization.

With continued reference to FIG. 13D, in some embodiments, for each data segment, the computing device determines (1340) (e.g., dynamically, in real time, on-the-fly) a respective tolerance value, for the respective data segment, according to characteristics of the respective fourth subset of data points. The computing device, in accordance with a determination that the respective fourth subset of data points (e.g., each data point in the respective third subset) satisfies (1342) the respective tolerance value, retains the respective fourth subset of data points and includes (e.g., adds) the respective fourth subset of data points in the final subset of final points. In some embodiments, the computing device, in accordance with a determination that the respective fourth subset of data points does not satisfy (1344) the respective tolerance value, divides the data segment into one or more sub-segments and reapplies the first algorithm to each of the sub-segments.

Referring now to FIG. 13E, in some embodiments, the computing device, at a respective computation pipeline corresponding to a respective data segment, divides (1346) the respective data segment into one or more data regions. A data region is a closely spaced data tuple which, when rendered, will be occupying a specific region of the screen.

For example, in a segment of 20 values below, there will be six data regions based on the data characteristics defined above:
{2,3.1, 18, 230, 1,0, 9, 3,4,1,78,56,32,18,16,12,1,109,11,20}→{2,3.1,1,0,3,4,1,1}, {9,12,11}, {18,18,16,20}, {230}, {78,56}, {32}, and {109}}

For each data region, the computing device determines (1348) a value for a visual change parameter (e.g., visual change parameter) for the data visualization when data values of the data region are included an existing rendering of the data visualization. In accordance with a determination that the value for visual change parameter satisfies a threshold value, the computing device adds (1350) the data region to the at least a portion of each data segment and reapplies the first algorithm to the at least a portion of each data segment.

The computing device renders (1352) (e.g., generates) a data visualization (e.g., data visualization 1020) using the browser application (e.g., natively or locally on the device, without any server-side interaction). The data visualization includes a plurality of data marks corresponding to the final subset of data points (e.g., each data mark corresponds to a data point in the final subset of data points) (e.g., 100% client-side rendering, rendering is performed in the web browser application).

In some embodiments, the data visualization is (1354) a Sankey chart, a tree map, a stacked bar graph, or a scatter plot.

In some embodiments, the data visualization is (1356) a line chart.

In some embodiments, the disclosed algorithm (e.g., algorithm(s) 1136) follows a defined strategy for a respective chart type. For example, for scatter chart, the algorithm can use a cluster modification algorithm such as Density-Based Spatial Clustering of Applications with Noise (DBSCAN) with Euclidean distance before applying the DP algorithm. In the case of a bar chart, the algorithm adds buckets and aggregation (by combining adjacent bars—wider bars) and then applying DP algorithm.

In some embodiments, for Sankey charts, the tolerance calculation for the DP algorithm is based on flow width (e.g., a minimum width of the flows to ensure that significant flows are preserved) and path deviation (e.g., a perpendicular distance between the original path and its simplified version).

In some embodiments, for tree maps, the tolerance includes rectangle size (e.g., based on the percentage deviation allowed in rectangle sizes while preserving the hierarchical structure) and position deviation (e.g., deviations in rectangle positions to maintain the overall structure).

The computing device displays (1358), on the browser application, the data visualization including the plurality of data marks.

Referring to FIG. 13F, in some embodiments, after displaying the data visualization on the browser application, the computing device receives (1360) user selection of a first region of the data visualization. The first region includes at least one data mark of the plurality of data marks. The computing device, in response to receiving the user selection of the first region of the data visualization, identifies (1362) a first node, in the data structure, corresponding to the first region of the data visualization. In accordance with a determination that the first node includes one or more data points that are excluded from the final subset of data points, the computing device re-renders (1366) (e.g., dynamically, in-real time) the first region of the data visualization to include one or more additional data marks, corresponding to the one or more data points; and displays the re-rendered first region of the data visualization.

For example, when a user wishes to explore a segment of the data visualization, the user can move their cursor around the segment. In some embodiments, the algorithm tracks the pixel movement using a separate web worker (separate from web workers of the main thread which render the visualization). As soon as the algorithm determines that the user is trying to move to a rectangle rectangular quarter, a quadrant which is already being sampled, it will trigger a spawning of a new web worker which would try to flash render the specific quadrant where the user is trying to move so that the user does not lose the fidelity of that specific area that specific segment.

In accordance with some embodiments, for a visualization with 10 million data points, the disclosed approach reduces JavaScript memory by ˜78% (e.g., from 275 MB to 63 MB in benchmark); the rendering time reduces by ˜99% (e.g., from 6 seconds to 50 milliseconds in benchmark); and the load time (user visual latency) decreases by ˜90% (from 16.9 seconds to 1.8 seconds for parent charting function). The gains are highly configurable since the optimization uses dynamic run-time tolerance (e.g., a function of DP algorithm) and adaptive quadtree nodes (e.g., minimum 15% with least tolerance and 99% with max tolerance).

Table 3 below shows the optimized performance values compared to the baseline values, in accordance with some embodiments.

TABLE 3
Performance Values

| | | | JavaScript | | | | | |
|---|---|---|---|---|---|---|---|---|
| | | | Memory | | Rendering | | | |
| Type | Element | Chart Type | (Average) | | Time | | Load Time | |
| Baseline | Scalable Vector | Line/Bar | 275 | MB | 6 | s | 16.9 | sec |
| | Graphics (SVG) | | | | | | | |
| Baseline | Canvas | Scatterplot | 112 | MB | 800 | ms | 11 | sec |
| Optimized | SVG | Line/Bar | 63 | MB | 50 | ms | 1.78 | sec |
| Optimized | Canvas | Scatterplot | 71 | MB | 18 | ms | 1.5 | sec |

Although FIGS. 13A to 13F illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

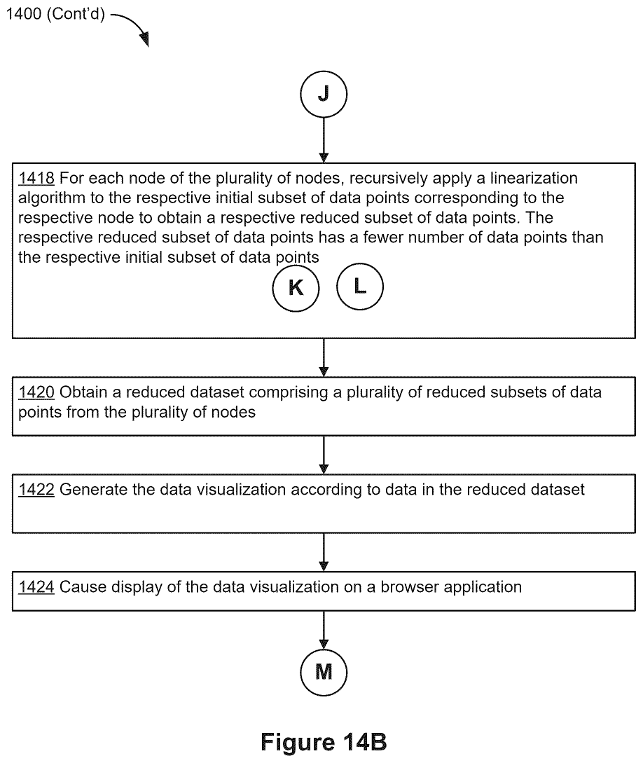

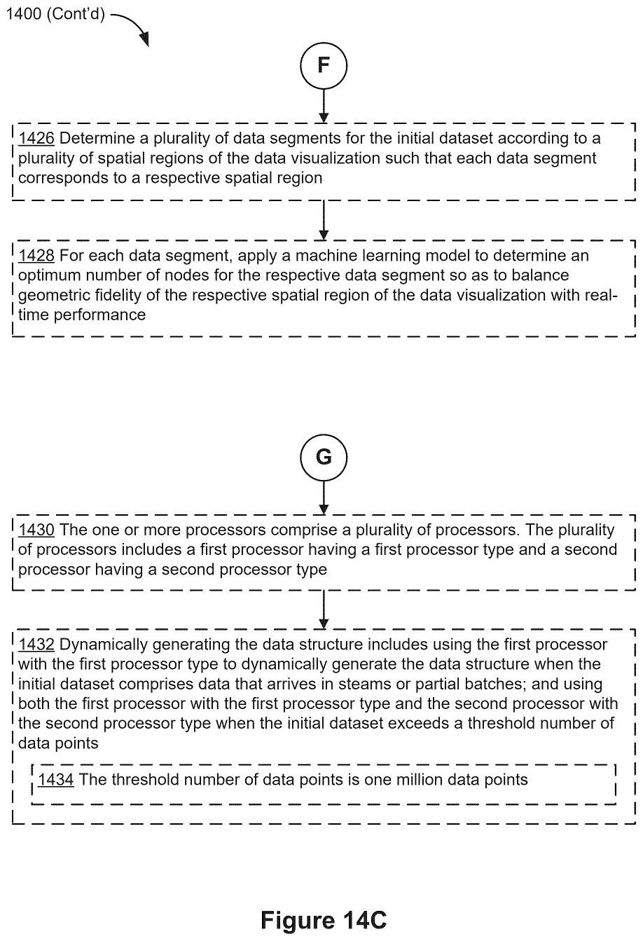

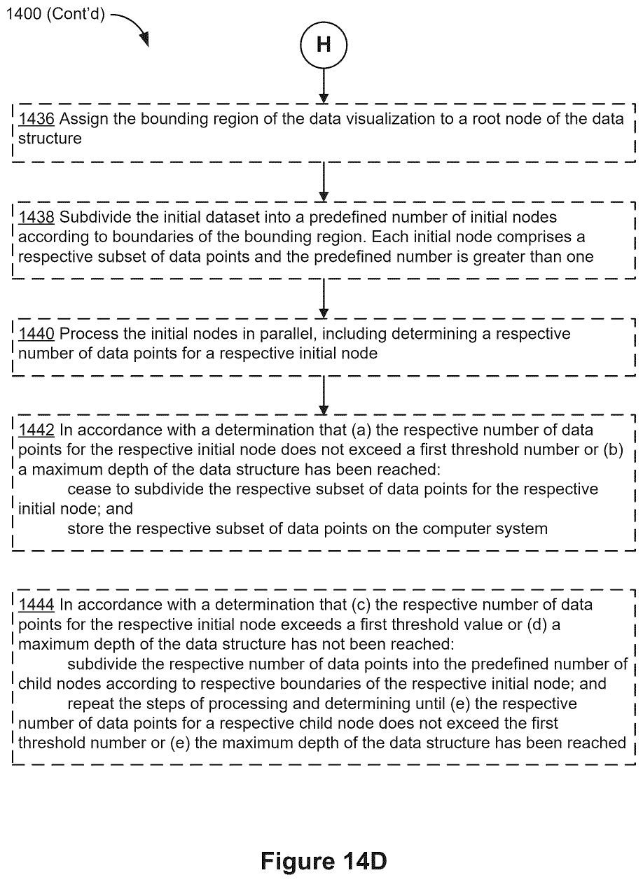

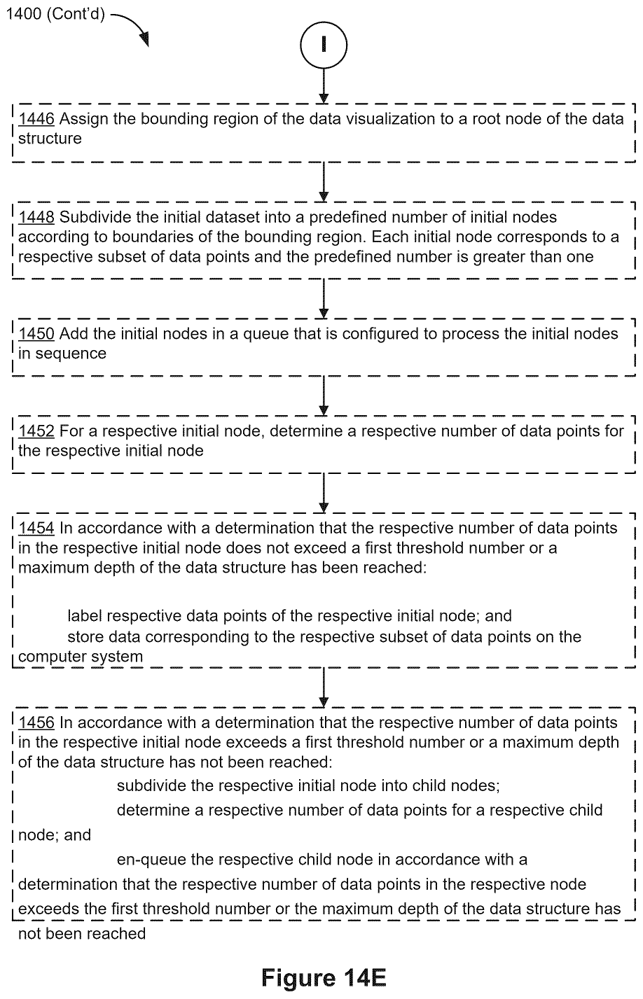

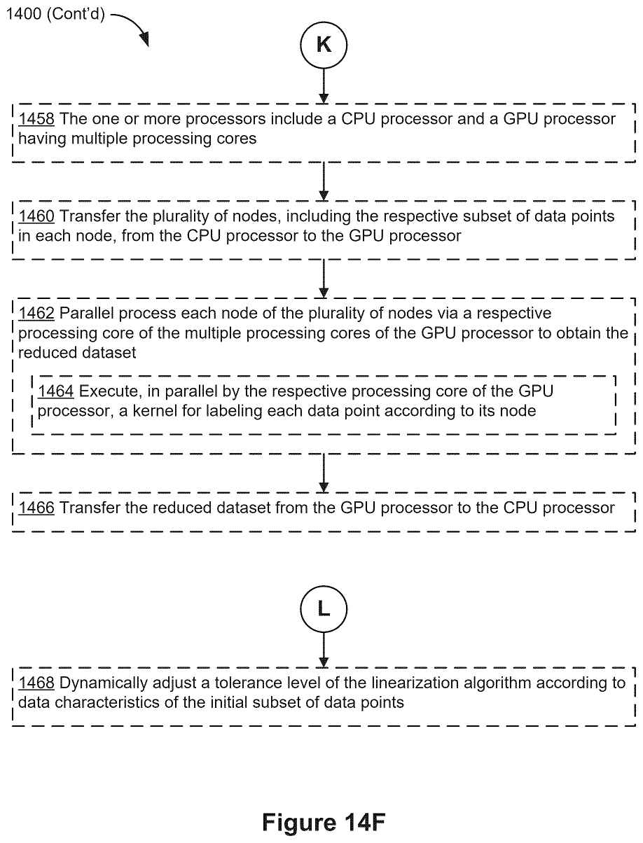

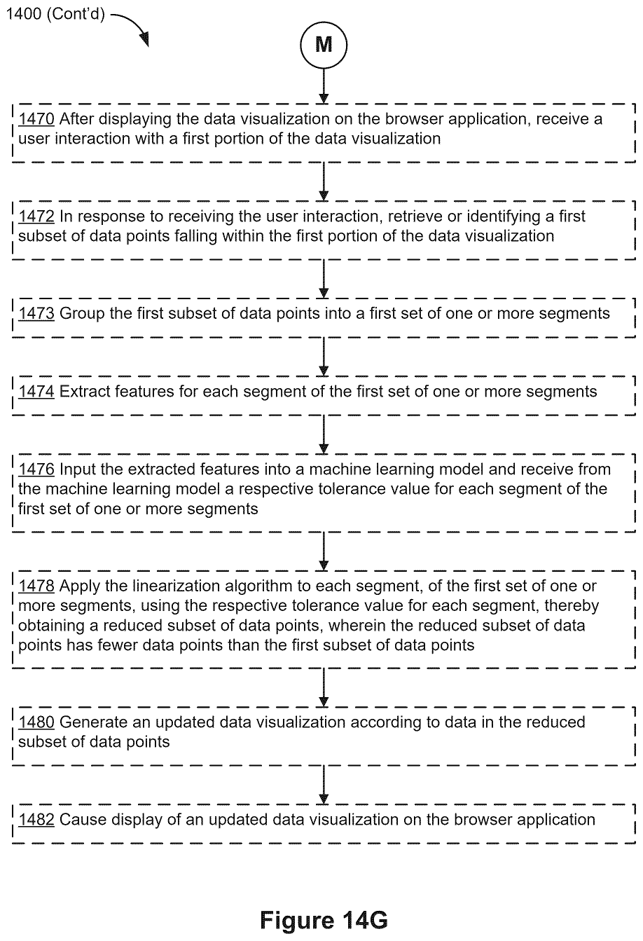

FIGS. 14A to 14G provide a flowchart of an example process for visualizing large datasets, in accordance with some embodiments. The method 1400 is performed at a computer system. In some embodiments, the computer system comprises computing device 1100. In some embodiments, the computer system comprises server system 1200. In some embodiments, the computer system comprises a combination of computing device 1100 and server system 1200. The computer system includes one or more processors and memory. In some embodiments, the memory stores one or more programs or instructions configured for execution by the one or more processors. In some embodiments, the operations shown in FIGS. 1, 2, 3A, 3B, 4, 5, 6, 7, 8, 9, and 10A-10C correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 1400 may be combined with the method 1300, and/or the order of some operations may be changed.

Referring to FIG. 14A, the computer system obtains (1402) an initial dataset for rendering a data visualization. This is illustrated in step 110 of pipeline 100 (data ingestion step). The initial dataset includes a plurality of data points that is spatially distributed in the data visualization and each data point has a respective spatial location in the data visualization (i.e., the data points occupy a 2D space in the data visualization).

In some embodiments, the initial dataset comprises a dataset of raw data (e.g., polylines, point sets, or map features). The computer system performs (1404) data cleaning on the dataset of raw data prior to generating the data structure. This is illustrated in step 112 of the pipeline 100.

The computer system dynamically generates (1406) a data structure. This is illustrated in step 114 of the pipeline 100. In some embodiments, dynamically generating the data structure including recursively subdividing (1408) (e.g., grouping, allocating, or assigning) a bounding region of the data visualization into a plurality of nodes (e.g., quadrants) until each node satisfies a set of one or more criteria; and allocating (1410) (e.g., assigning) a respective initial subset of data points, of the plurality of data points, to each node of the plurality of nodes according to a spatial location of a respective data point in the data visualization. The bounding region is the spatial region occupied by the data visualization. The plurality of data points are recursively divided into the plurality of nodes according to a spatial location of the data point in the data visualization. Each node corresponds to a respective spatial region of the data visualization. For example, each data point is assigned to one node (e.g., a leaf node) (e.g., leaf node 314, FIG. 3B).

FIGS. 14B, 14C, and 14D illustrate various ways of dynamically generating the data structure.

Referring to FIG. 14B, in some embodiments, dynamically generating the data structure includes determining (1426) by the computer system a plurality of data segments for the initial dataset according to a plurality of spatial regions of the data visualization such that each data segment corresponds to a respective spatial region. In some embodiments, for each data segment, the computer system applies (1428) a machine learning model (e.g., machine learning model 1160) to determine (e.g., predict) an optimum number of nodes for the respective data segment so as to balance geometric fidelity of the respective spatial region of the data visualization with real-time performance. For example, areas of high user interest or significant local variance might receive extra subdivision or lower tolerances, whereas less critical regions could be simplified more aggressively.

In some embodiments, the one or more processors of the computer system comprise (1430) a plurality of processors. The plurality of processors including a first processor having a first processor type and a second processor having a second processor type. In some embodiments, dynamically generating the data structure includes using (1432) the first processor with the first processor type to dynamically generate the data structure when the initial dataset comprises data that arrives in steams or partial batches; and using both the first processor with the first processor type and the second processor with the second processor type when the initial dataset exceeds a threshold number of data points.

In some embodiments, the threshold number of data points is (1434) one million data points. In some embodiments, the threshold number of data points is two million, three million, four million, five million, six million, or over six million data points.

Referring to FIG. 14C, in some embodiments, the data structure construction process comprises a CPU-driven QuadTree construction process. For example, FIG. 4 shows an example algorithm for CPU-driven QuadTree construction. In some embodiments, dynamically generating the data structure includes assigning (1436), by the computer system, the bounding region of the data visualization to a root node of the data structure. In some embodiments, the computer system subdivides (1438) the initial dataset into a predefined number of initial nodes (e.g., four nodes or quadrants) according to boundaries (e.g., quadrant boundaries) of the bounding region. Each initial node comprises a respective subset of data points and the predefined number is greater than one. In some embodiments, the computer system processes (1440) the initial nodes in parallel, including determining a respective number of data points for a respective initial node. In some embodiments, the computer system, in accordance with a determination (1442) that (a) the respective number of data points for the respective initial node does not exceed a first threshold number (e.g., a node has fewer than maxNodes) or (b) a maximum depth of the data structure has been reached: ceases to subdivide the respective subset of data points for the respective initial node; and stores the respective subset of data points on the computer system. In some embodiments, the computer system, in accordance with a determination (1444) that (c) the respective number of data points for the respective initial node exceeds a first threshold value (e.g., a node has greater than maxNodes) or (d) a maximum depth of the data structure has not been reached: subdivides the respective number of data points into the predefined number of child nodes according to respective boundaries of the respective initial node; and repeats the steps of processing and determining until (e) the respective number of data points for a respective child node does not exceed the first threshold number or (e) the maximum depth of the data structure has been reached. In some embodiments, CPU-driven QuadTree construction process is suited for scenarios where data arrives in streams or partial batches.

Referring to FIG. 14D, in some embodiments, the data structure is constructed with assistance from one or more GPUs of the computer system (e.g., GPU-assisted Quadtree construction). FIG. 5 shows an example algorithm for GPU-driven QuadTree construction. In some embodiments, dynamically generating the data structure includes assigning (1446) by the computer system the bounding region to a root node of the data structure. In some embodiments, the computer system subdivides (1448) the initial dataset into a predefined number of initial nodes (e.g., four nodes or quadrants) according to boundaries (e.g., quadrant boundaries) of the bounding region, where each initial node corresponds to a respective subset of data points and the predefined number is greater than one. In some embodiments, the computer system adds (1450) the initial nodes in a queue that is configured to process the initial nodes in sequence (e.g., rather than relying on deep recursion, which can be beneficial for both CPU and GPU memory management).

For a respective initial node, the computer system determines (1452) a respective number of data points for the respective initial node. In some embodiments, the computer system, in accordance with a determination (1454) that the respective number of data points in the respective initial node does not exceed a first threshold number (e.g., a node has fewer than maxNodes) or a maximum depth of the data structure has been reached: labels respective data points of the respective initial node; and stores data corresponding to the respective subset of data points on the computer system. For example, a specialized kernel is configured to quickly label each point according to its quadrant. In some embodiments, threads run in parallel for each data point, reducing classification time.

In some embodiments, the computer system, in accordance with a determination (1456) that the respective number of data points in the respective initial node exceeds a first threshold number (e.g., a node has greater than maxNodes) or a maximum depth of the data structure has not been reached: subdivides the respective initial node into child nodes; determines a respective number of data points for a respective child node; and en-queues the respective child node (adding the respective child node to the queue) in accordance with a determination that the respective number of data points in the respective node exceeds the first threshold number or the maximum depth of the data structure has not been reached.

Referring back to FIG. 14A, in some embodiments, the set of one or more criteria includes (1412) one or more of: a first criterion that specifies a minimum number of data points in a node (Min Nodes); a second criterion that specifies a maximum number of data points in a node (Max Nodes); a third criterion that specifies a minimum and/or maximum size of a region of the respective subset of data points corresponding to the respective node; and a fourth criterion that specifies a maximum local variance of the respective subset of data points corresponding to the respective node.

In some embodiments, the data structure comprises (1414) a quadtree data structure. This is illustrated in, e.g., FIGS. 3A and 3B.

In some embodiments, the computer system stores (1416) each data point of the initial dataset in a binary data format in the data structure.

Referring now to FIG. 14B. for each node of the plurality of nodes (wherein each node includes a corresponding subset of data points), the computer system recursively applies (1418) a linearization algorithm (e.g., a line simplification algorithm, such as the Douglas-Peucker algorithm or the VW algorth,) to the respective initial subset of data points corresponding to the respective node to obtain a respective reduced subset of data points. The respective reduced subset of data points has a fewer number of data points than the respective initial subset of data points.

FIG. 14F illustrates various ways of recursively applying the linearization algorithm.

In some embodiments, the one or more processors of the computer system include (1458) a CPU processor and a GPU processor having multiple processing cores. Recursively applying a linearization algorithm includes transferring (1460) the plurality of nodes, including the respective subset of data points in each node, from the CPU processor to the GPU processor; parallel processing (1462) each node of the plurality of nodes via a respective processing core of the multiple processing cores of the GPU processor to obtain the reduced dataset; and transferring (1466) the reduced dataset from the GPU processor to the CPU processor. Each QuadTree leaf or subset typically contains far fewer points than the entire dataset.

In some embodiments, the parallel processing includes executing (1464), in parallel by the respective processing core of the GPU processor, a kernel (e.g., function) for labeling each data point according to its node.

In some embodiments, recursively applying the linearization algorithm includes dynamically adjusting (1468) a tolerance level of the linearization algorithm according to data characteristics of the initial subset of data points.

With continued reference to FIG. 14B, the computer system obtains (1420) a reduced dataset comprising a plurality of reduced subsets of data points from the plurality of nodes.

The computer system generates (1422) the data visualization according to data in the reduced dataset.

The computer system causes (1424) display of the data visualization on a browser application.

Referring to FIG. 14G, in some embodiments, the computer system, after displaying the data visualization on the browser application, receives (1470) a user interaction with a first portion of the data visualization. For example, the user interaction is a pan, zoom, or filter interaction, as illustrated in step 130 of pipeline 100.

In some embodiments, the computer system, in response to receiving the user interaction, retrieves (1472) or identifies a first subset of data points falling within the first portion of the data visualization. The computer system groups (1473) the first subset of data points into a first set of one or more segments. The computer system extracts (1474) features for each segment of the first set of one or more segments. The computer system inputs (1476) the extracted features into a machine learning model and receives from the machine learning model a respective tolerance value for each segment of the first set of one or more segments. The computer system applies (1778) the linearization algorithm to each segment, of the first set of one or more segments, using the respective tolerance value for each segment, thereby obtaining a reduced subset of data points. The reduced subset of data points has fewer data points than the first subset of data points. The computer system generates (1480) an updated data visualization according to data in the reduced subset of data points. The computer system causes (1482) display of an updated data visualization on the browser application. In some embodiments, the updated data visualization comprises a view of only the first portion of the data visualization.

Although FIGS. 14A to 14G illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments:
(A1) In accordance with some embodiments, a method for visualizing large datasets is performed by a computing device executing a browser application. The method comprises: obtaining a dataset for rendering a data visualization, the dataset including a plurality of data points; selecting, from the plurality of data points, a first subset of data points according to a statistical data distribution of the dataset; recursively applying a first algorithm to the first subset of data points to obtain a final subset of data points, wherein each of first subset of data points and the final subset of data points has a fewer number of data points than the plurality of data points; rendering a data visualization using the browser application, the data visualization having a plurality of data marks corresponding to the final subset of data points; and displaying, on the browser application, the data visualization including the plurality of data marks.
(A2) In some embodiments of A1, recursively applying the first algorithm to the first subset of data points to obtain the final subset of data points includes: applying the first algorithm to the first subset of data points to obtain a second subset of data points; dividing the second subset of data points into multiple data segments, each of the data segments including a respective third subset of data points; and reapplying the first algorithm to a least a portion of each data segment, of the multiple data segments, to obtain a respective fourth subset of data points from the respective third subset of data points.
(A3) In some embodiments of A2, reapplying the first algorithm to the a least a portion of each data segment to obtain the respective fourth subset of data points comprises, for each data segment: determining a respective tolerance value for the data segment according to characteristics of the respective fourth subset of data points; in accordance with a determination that the respective fourth subset of data points satisfy the respective tolerance value: (i) retaining the respective fourth subset of data points; and (ii) including the respective fourth subset of data points in the final subset of final points; and in accordance with a determination that the respective fourth subset of data points do not satisfy the respective tolerance value: (a) dividing the data segment into one or more sub-segments; and (b) reapplying the first algorithm to each of the sub-segments.
(A4) In some embodiments of any of A2-A3, the method further comprises generating a distinct computation pipeline for each data segment, of the multiple data segments, to independently process the data segment.
(A5) In some embodiments of A4, the method further comprises, at a respective computation pipeline corresponding to a respective data segment: dividing the respective data segment into one or more data regions; and for each data region: determining a value for a visual change parameter for the data visualization when data values of the data region are included an existing rendering of the data visualization; and in accordance with a determination that the value for visual change parameter satisfies a threshold value: (a) adding the data region to the at least a portion of each data segment; and (b) reapplying the first algorithm to the a least a portion of each data segment.
(A6) In some embodiments of any of A1-A5, the method further comprises, after obtaining the dataset: generating a data structure that includes a plurality of nodes; and assigning each data point of the dataset to a respective node of the data structure according to a spatial location of the respective data point in the data visualization.
(A7) In some embodiments of A6, the method further comprises storing each data point of the dataset in a binary data format in the data structure.
(A8) In some embodiments of A6 or A7, wherein the data structure comprises a quadtree data structure.
(A9) In some embodiments of any of A6-A8, the data visualization occupies a spatial area; and the method includes: partitioning the spatial area into four quadrants; and for a respective quadrant: (a) recursively partitioning the quadrant to sub-quadrants in accordance with a determination that a first set of criteria is satisfied; and (b) assigning a respective data point to a respective sub-quadrant according to respective coordinates of the data point.
(A10) In some embodiments of A9, the first set of criteria includes a criterion that a number of data points corresponding to the respective quadrant exceeds a threshold number of data points.
(A11) In some embodiments of any of A6-A10, the method further comprises: after displaying, on the browser application, the data visualization: receiving user selection of a first region of the data visualization, the first region including at least one data mark of the plurality of data marks; and in response to receiving the user selection of the first region of the data visualization: identifying a first node, in the data structure, corresponding to the first region of the data visualization; in accordance with a determination that the first node includes one or more data points that are excluded from the final subset of data points: re-rendering the first region of the data visualization to include one or more additional data marks, corresponding to the one or more data points; and displaying the re-rendered first region of the data visualization.
(A12) In some embodiments of any of A1-A11, the method further comprises after obtaining the dataset and prior to selecting the first subset of data points: performing initial data cleaning and transformation.
(A13) In some embodiments of any of A1-A12, the method further comprises after obtaining the dataset and prior to selecting the first subset of data points: performing feature extraction on the dataset to identify, from the plurality of data points, an initial subset of data points that retains a visual perception of the data visualization.
(A14) In some embodiments of any of A1-A13, the selecting the first subset of data points is further based on a data mark encoding type of the data visualization.
(A15) In some embodiments of any of A1-A14, wherein selecting, from the plurality of data points, the first subset of data points according to the data distribution of the dataset includes: applying a machine learning model to determine, from the statistical data distribution, the first subset of data points such that the first subset of data points preserves a visual perception of the data visualization.
(A16) In some embodiments of any of A1-A15, wherein selecting, from the plurality of data points, the first subset of data points according to the data distribution of the dataset includes: applying a machine learning model to determine, from the statistical data distribution, a second subset of data points from the plurality of data points; and performing a filtering or grouping operation on each data point of the second subset of data points.
(A17) In some embodiments of any of A1-A16, the first subset of data points is selected further based on a chart type of the data visualization.
(A18) In some embodiments of any of A1-A17, wherein the data visualization is a Sankey chart, a tree map, a stacked bar graph, or a scatter plot.
(A19) In some embodiments of any of A1-A18, wherein the data visualization is a line chart.
(B1) In accordance with some embodiments, a computing device comprises a display; one or more processors; and memory coupled to the one or more processors, the memory storing one or more programs configured for execution by the one or more processors, the one or more programs including instructions for performing the method of any of A1-A19.
(C1) In accordance with some embodiments, a computer-readable medium storing one or more programs configured for execution by one or more processors of a computing device, the one or more programs comprising instructions for performing the method of any of claims A1-A19.
(D1) In accordance with some embodiments, a method of visualizing large-scale datasets is performed at a computer system that includes one or more processors and memory. The method includes obtaining an initial dataset for rendering a data visualization, the initial dataset including a plurality of data points that is spatially distributed in the data visualization and each data point has a respective spatial location in the data visualization; dynamically generating a data structure, including: (i) recursively subdividing a bounding region of the data visualization into a plurality of nodes until each node satisfies a set of one or more criteria; and (ii) allocating a respective initial subset of data points, of the plurality of data points, to each node of the plurality of nodes according to a spatial location of a respective data point in the data visualization; for each node of the plurality of nodes, recursively applying a linearization algorithm to the respective initial subset of data points corresponding to the respective node to obtain a respective reduced subset of data points, wherein the respective reduced subset of data points has a fewer number of data points than the respective initial subset of data points; obtaining a reduced dataset comprising a plurality of reduced subsets of data points from the plurality of nodes; generating the data visualization according to data in the reduced dataset; and causing display of the data visualization on a browser application.
(D2) In some embodiments of D1, wherein dynamically generating the data structure includes: determining a plurality of data segments for the initial dataset according to a plurality of spatial regions of the data visualization such that each data segment corresponds to a respective spatial region; and for each data segment, applying a machine learning model to determine an optimum number of nodes for the respective data segment so as to balance geometric fidelity of the respective spatial region of the data visualization with real-time performance.
(D3) In some embodiments of any of D1-D2, the one or more processors comprise a plurality of processors, the plurality of processors including a first processor having a first processor type and a second processor having a second processor type; and dynamically generating the data structure includes: (a) using the first processor with the first processor type to dynamically generate the data structure when the initial dataset comprises data that arrives in steams or partial batches; and (b) using both the first processor with the first processor type and the second processor with the second processor type when the initial dataset exceeds a threshold number of data points.
(D4) In some embodiments of D3, the threshold number of data points is one million data points.
(D5) In some embodiments of any of D1-D4, wherein dynamically generating the data structure includes: assigning the bounding region of the data visualization to a root node of the data structure; subdividing the initial dataset into a predefined number of initial nodes according to boundaries of the bounding region, wherein each initial node comprises a respective subset of data points and the predefined number is greater than one; processing the initial nodes in parallel, including determining a respective number of data points for a respective initial node: in accordance with a determination that (a) the respective number of data points for the respective initial node does not exceed a first threshold number or (b) a maximum depth of the data structure has been reached: (1) ceasing to subdivide the respective subset of data points for the respective initial node; and (2) storing the respective subset of data points on the computer system; and in accordance with a determination that (c) the respective number of data points for the respective initial node exceeds a first threshold value or (d) a maximum depth of the data structure has not been reached: (3) subdividing the respective number of data points into the predefined number of child nodes according to respective boundaries of the respective initial node; and (4) repeating the steps of processing and determining until (e) the respective number of data points for a respective child node does not exceed the first threshold number or (f) the maximum depth of the data structure has been reached.
(D6) In some embodiments of any of D1-D5, wherein dynamically generating the data structure includes: assigning the bounding region to a root node of the data structure; subdividing the initial dataset into a predefined number of initial nodes according to boundaries of the bounding region, wherein each initial node corresponds to a respective subset of data points and the predefined number is greater than one; adding the initial nodes in a queue that is configured to process the initial nodes in sequence; and for a respective initial node: determining a respective number of data points for the respective initial node; in accordance with a determination that the respective number of data points in the respective initial node does not exceed a first threshold number or a maximum depth of the data structure has been reached: (a) labeling respective data points of the respective initial node; and (b) storing data corresponding to the respective subset of data points on the computer system; and in accordance with a determination that the respective number of data points in the respective initial node exceeds a first threshold number or a maximum depth of the data structure has not been reached: (c) subdividing the respective initial node into child nodes; (d) determining a respective number of data points for a respective child node; and (e) en-queuing the respective child node in accordance with a determination that the respective number of data points in the respective node exceeds the first threshold number or the maximum depth of the data structure has not been reached.
(D7) In some embodiments of any of D1-D6, wherein the one or more processors include a CPU processor and a GPU processor having multiple processing cores; and recursively applying a linearization algorithm includes: (a) transferring the plurality of nodes, including the respective subset of data points in each node, from the CPU processor to the GPU processor; (b) parallel processing each node of the plurality of nodes via a respective processing core of the multiple processing cores of the GPU processor to obtain the reduced dataset; and (c) transferring the reduced dataset from the GPU processor to the CPU processor, wherein the generating and the causing display are performed via the CPU processor.
(D8) In some embodiments of D7, wherein the parallel processing includes executing, in parallel by the respective processing core of the GPU processor, a kernel for labeling each data point according to its node.
(D9) In some embodiments of any of D1-D8, wherein recursively applying the linearization algorithm includes dynamically adjusting a tolerance level of the linearization algorithm according to data characteristics of the initial subset of data points.
(D10) In some embodiments of any of D1-D9, the method further comprises: after displaying the data visualization on the browser application, receiving a user interaction with a first portion of the data visualization; in response to receiving the user interaction: (a) retrieving or identifying a first subset of data points falling within the first portion of the data visualization; (b) grouping the first subset of data points into a first set of one or more segments; (c) extracting features for each segment of the first set of one or more segments; (d) inputting the extracted features into a machine learning model and receiving from the machine learning model a respective tolerance value for each segment of the first set of one or more segments; and (e) applying the linearization algorithm to each segment, of the first set of one or more segments, using the respective tolerance value for each segment, thereby obtaining a reduced subset of data points, wherein the reduced subset of data points has fewer data points than the first subset of data points; (f) generating an updated data visualization according to data in the reduced subset of data points; and (g) causing display of an updated data visualization on a browser application.
(D11) In some embodiments of any of D1-D10, the initial dataset comprises a dataset of raw data; and the method includes performing data cleaning on the dataset of raw data prior to generating the data structure.
(D12) In some embodiments of any of D1-D11, wherein the set of one or more criteria includes at least two of: (1) a first criterion that specifies a minimum number of data points in a node (Min Nodes); (2) a second criterion that specifies a maximum number of data points in a node (Max Nodes); (3) a third criterion that specifies a minimum and/or maximum size of a region of the respective subset of data points corresponding to the respective node; and (4) a fourth criterion that specifies a maximum local variance of the respective subset of data points corresponding to the respective node.
(D13) In some embodiments of any of D1-D12, further comprising storing each data point of the initial dataset in a binary data format in the data structure.
(D14) In some embodiments of any of D1-D13, wherein the data structure comprises a quadtree data structure.
(E1) In accordance with some embodiments, a computer system includes one or more processors; and memory coupled to the one or more processors, the memory storing one or more programs configured for execution by the one or more processors, the one or more programs including instructions for performing the method of any of D1-D14.
(F1) In accordance with some embodiments, a computer-readable medium storing one or more programs configured for execution by one or more processors of a computer system, the one or more programs comprising instructions for performing the method of any of claims D1-D14.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of visualizing large-scale datasets, comprising:
at a computer system that includes one or more processors and memory:
obtaining an initial dataset for rendering a data visualization, the initial dataset including a plurality of data points that is spatially distributed in the data visualization and each data point has a respective spatial location in the data visualization;
dynamically generating a data structure, including:
recursively subdividing a bounding region of the data visualization into a plurality of nodes until each node satisfies a set of one or more criteria; and
allocating a respective initial subset of data points, of the plurality of data points, to each node of the plurality of nodes according to a spatial location of a respective data point in the data visualization;
for each node of the plurality of nodes, recursively applying a linearization algorithm to the respective initial subset of data points corresponding to the respective node to obtain a respective reduced subset of data points, wherein the respective reduced subset of data points has a fewer number of data points than the respective initial subset of data points;
obtaining a reduced dataset comprising a plurality of reduced subsets of data points from the plurality of nodes;
generating the data visualization according to data in the reduced dataset; and
causing display of the data visualization on a browser application.

2. The method of claim 1, wherein dynamically generating the data structure includes:
determining a plurality of data segments for the initial dataset according to a plurality of spatial regions of the data visualization such that each data segment corresponds to a respective spatial region; and
for each data segment:
applying a machine learning model to determine an optimum number of nodes for the respective data segment so as to balance geometric fidelity of the respective spatial region of the data visualization with real-time performance.

3. The method of claim 1, wherein:
the one or more processors comprise a plurality of processors, the plurality of processors including a first processor having a first processor type and a second processor having a second processor type; and
dynamically generating the data structure includes:
using the first processor with the first processor type to dynamically generate the data structure when the initial dataset comprises data that arrives in steams or partial batches; and
using both the first processor with the first processor type and the second processor with the second processor type when the initial dataset exceeds a threshold number of data points.

4. The method of claim 3, wherein the threshold number of data points is one million data points.

5. The method of claim 1, wherein dynamically generating the data structure includes:
assigning the bounding region of the data visualization to a root node of the data structure;
subdividing the initial dataset into a predefined number of initial nodes according to boundaries of the bounding region, wherein each initial node comprises a respective subset of data points and the predefined number is greater than one;
processing the initial nodes in parallel, including determining a respective number of data points for a respective initial node:
in accordance with a determination that (a) the respective number of data points for the respective initial node does not exceed a first threshold number or (b) a maximum depth of the data structure has been reached:
ceasing to subdivide the respective subset of data points for the respective initial node; and
storing the respective subset of data points on the computer system; and
in accordance with a determination that (c) the respective number of data points for the respective initial node exceeds a first threshold value or (d) a maximum depth of the data structure has not been reached:
subdividing the respective number of data points into the predefined number of child nodes according to respective boundaries of the respective initial node; and
repeating the steps of processing and determining until (e) the respective number of data points for a respective child node does not exceed the first threshold number or (f) the maximum depth of the data structure has been reached.

6. The method of claim 1, wherein dynamically generating the data structure includes:
assigning the bounding region to a root node of the data structure;
subdividing the initial dataset into a predefined number of initial nodes according to boundaries of the bounding region, wherein each initial node corresponds to a respective subset of data points and the predefined number is greater than one;
adding the initial nodes in a queue that is configured to process the initial nodes in sequence; and
for a respective initial node:
determining a respective number of data points for the respective initial node;
in accordance with a determination that the respective number of data points in the respective initial node does not exceed a first threshold number or a maximum depth of the data structure has been reached:
labeling respective data points of the respective initial node; and
storing data corresponding to the respective subset of data points on the computer system; and
in accordance with a determination that the respective number of data points in the respective initial node exceeds a first threshold number or a maximum depth of the data structure has not been reached:
subdividing the respective initial node into child nodes;
determining a respective number of data points for a respective child node; and
en-queuing the respective child node in accordance with a determination that the respective number of data points in the respective node exceeds the first threshold number or the maximum depth of the data structure has not been reached.

7. The method of claim 1, wherein:
the one or more processors include a CPU processor and a GPU processor having multiple processing cores; and
recursively applying a linearization algorithm includes:
transferring the plurality of nodes, including the respective subset of data points in each node, from the CPU processor to the GPU processor;
parallel processing each node of the plurality of nodes via a respective processing core of the multiple processing cores of the GPU processor to obtain the reduced dataset; and
transferring the reduced dataset from the GPU processor to the CPU processor, wherein the generating and the causing display are performed via the CPU processor.

8. The method of claim 7, wherein the parallel processing includes executing, in parallel by the respective processing core of the GPU processor, a kernel for labeling each data point according to its node.

9. The method of claim 1, wherein recursively applying the linearization algorithm includes dynamically adjusting a tolerance level of the linearization algorithm according to data characteristics of the initial subset of data points.

10. The method of claim 1, further comprising:
after displaying the data visualization on the browser application, receiving a user interaction with a first portion of the data visualization;
in response to receiving the user interaction:
retrieving or identifying a first subset of data points falling within the first portion of the data visualization;
grouping the first subset of data points into a first set of one or more segments;
extracting features for each segment of the first set of one or more segments;
inputting the extracted features into a machine learning model and receiving from the machine learning model a respective tolerance value for each segment of the first set of one or more segments; and
applying the linearization algorithm to each segment, of the first set of one or more segments, using the respective tolerance value for each segment, thereby obtaining a reduced subset of data points, wherein the reduced subset of data points has fewer data points than the first subset of data points;
generating an updated data visualization according to data in the reduced subset of data points; and
causing display of an updated data visualization on a browser application.

11. The method of claim 1, wherein:
the initial dataset comprises a dataset of raw data; and
the method includes performing data cleaning on the dataset of raw data prior to generating the data structure.

12. The method of claim 1, wherein the set of one or more criteria includes at least two of:
a first criterion that specifies a minimum number of data points in a node (Min Nodes);
a second criterion that specifies a maximum number of data points in a node (Max Nodes);
a third criterion that specifies a minimum and/or maximum size of a region of the respective subset of data points corresponding to the respective node; and
a fourth criterion that specifies a maximum local variance of the respective subset of data points corresponding to the respective node.

13. The method of claim 1, further comprising storing each data point of the initial dataset in a binary data format in the data structure.

14. The method of claim 1, wherein the data structure comprises a quadtree data structure.

15. A computer system, comprising:
one or more processors; and
memory coupled to the one or more processors, the memory storing one or more programs configured for execution by the one or more processors, the one or more programs including instructions for:
obtaining an initial dataset for rendering a data visualization, the initial dataset including a plurality of data points that is spatially distributed in the data visualization and each data point has a respective spatial location in the data visualization;
dynamically generating a data structure, including:
recursively subdividing a bounding region of the data visualization into a plurality of nodes until each node satisfies a set of one or more criteria; and
allocating a respective initial subset of data points, of the plurality of data points, to each node of the plurality of nodes according to a spatial location of a respective data point in the data visualization;
for each node of the plurality of nodes, recursively applying a linearization algorithm to the respective initial subset of data points corresponding to the respective node to obtain a respective reduced subset of data points, wherein the respective reduced subset of data points has a fewer number of data points than the respective initial subset of data points;
obtaining a reduced dataset comprising a plurality of reduced subsets of data points from the plurality of nodes;
generating the data visualization according to data in the reduced dataset; and
causing display of the data visualization on a browser application.

16. The computer system of claim 15, wherein:
the one or more processors include a CPU processor and a GPU processor having multiple processing cores; and
the instructions for recursively applying a linearization algorithm include instructions for:
transferring the plurality of nodes, including the respective subset of data points in each node, from the CPU processor to the GPU processor;
parallel processing each node of the plurality of nodes via a respective processing core of the multiple processing cores of the GPU processor to obtain the reduced dataset; and
transferring the reduced dataset from the GPU processor to the CPU processor, wherein the generating and the causing display are performed via the CPU processor.

17. The computer system of claim 16, wherein the instructions for parallel processing include instructions for executing, in parallel by the respective processing core of the GPU processor, a kernel for labeling each data point according to its node.

18. The computer system of claim 15, wherein the instructions for recursively applying the linearization algorithm include instructions for dynamically adjusting a tolerance level of the linearization algorithm according to data characteristics of the initial subset of data points.

19. The computer system of claim 15, the one or more programs further comprising instructions for:
after displaying the data visualization on the browser application, receiving a user interaction with a first portion of the data visualization;
in response to receiving the user interaction:
retrieving or identifying a first subset of data points falling within the first portion of the data visualization;
grouping the first subset of data points into a first set of one or more segments;
extracting features for each segment of the first set of one or more segments;
inputting the extracted features into a machine learning model and receiving from the machine learning model a respective tolerance value for each segment of the first set of one or more segments; and
applying the linearization algorithm to each segment, of the first set of one or more segments, using the respective tolerance value for each segment, thereby obtaining a reduced subset of data points, wherein the reduced subset of data points has fewer data points than the first subset of data points;
generating an updated data visualization according to data in the reduced subset of data points; and
causing display of an updated data visualization on the browser application.

20. A non-transitory computer-readable medium storing one or more programs configured for execution by one or more processors of a computer system, the one or more programs comprising instructions for:
obtaining an initial dataset for rendering a data visualization, the initial dataset including a plurality of data points that is spatially distributed in the data visualization and each data point has a respective spatial location in the data visualization;
dynamically generating a data structure, including:
recursively subdividing a bounding region of the data visualization into a plurality of nodes until each node satisfies a set of one or more criteria; and
allocating a respective initial subset of data points, of the plurality of data points, to each node of the plurality of nodes according to a spatial location of a respective data point in the data visualization;
for each node of the plurality of nodes, recursively applying a linearization algorithm to the respective initial subset of data points corresponding to the respective node to obtain a respective reduced subset of data points, wherein the respective reduced subset of data points has a fewer number of data points than the respective initial subset of data points;
obtaining a reduced dataset comprising a plurality of reduced subsets of data points from the plurality of nodes;
generating the data visualization according to data in the reduced dataset; and
causing display of the data visualization on a browser application.
